(19) United States
(12) Patent Application Publication
(10) Pub. No.: US 2023/0038336 A1
(43) Pub. Date: Feb. 9, 2023

(54) TRANSVERSELY-LOADABLE ROTISSERIE FORKS FOR GRILLS

(71) Applicant: Weber-Stephen Products LLC, Palatine, IL (US)

(72) Inventors: Christian Hyde, Schaumburg, IL (US); Daniel Ramirez, Des Plaines, IL (US); Robert Farmer, Naperville, IL (US); Romualdo Sonny Siazon, Woodstock, IL (US); Brian C. Donnelly, Naperville, IL (US); Cassandra A.S. McVey, Palatine, IL (US); Shannon Ella Cerny, Aurora, IL (US); Michelle Stohl, Glenview, IL (US)

(21) Appl. No.: 17/834,711

(22) Filed: Jun. 7, 2022

Related U.S. Application Data
(60) Provisional application No. 63/203,926, filed on Aug. 4, 2021.

(51) Int. Cl. A47J 37/07; A47J 37/04

(52) U.S. Cl. CPC A47J 37/0745; A47J 37/0786; A47J 37/041; A47J 2037/0795

(57) ABSTRACT

Example transversely-loadable rotisserie forks are disclosed. An example rotisserie fork includes a first upper prong and a second upper prong spaced apart from the first upper prong. The example rotisserie fork further includes a first lower prong and a second lower prong spaced apart from the first lower prong. The example rotisserie fork further includes a mounting bracket coupled to the first upper prong, the second upper prong, the first lower prong, and the second lower prong. The mounting bracket is configured to be transversely loadable onto a rotisserie spit.

### RELATED APPLICATIONS

This application claims priority to U.S. Provisional Patent Application No. 63/203,926, filed Aug. 4, 2021. The entirety of U.S. Provisional Patent Application No. 63/203,926 is hereby incorporated by reference herein.

### FIELD OF THE DISCLOSURE

This disclosure relates generally to rotisserie forks and, more specifically, to transversely-loadable rotisserie forks for grills.

### BACKGROUND

Rotisserie forks are routinely used in connection with grills (e.g., gas grills, charcoal grills, electric grills, etc.) to facilitate rotisserie-style cooking of one or more food item(s) (e.g., chickens, turkeys, roasts, primal cuts, etc.) within the grill. Known rotisserie forks typically include a mounting bracket having a centrally-located lateral (e.g., axial) passageway extending therethrough. The lateral passageway is configured to receive and/or accommodate the cross-sectional area of a rotisserie spit. In this regard, known rotisserie forks are configured to be attached to a rotisserie spit by (1) removing the rotisserie spit from its supported position on and/or within a cookbox of a grill, (2) loading the rotisserie fork onto an end of the rotisserie spit such that the lateral passageway of the mounting bracket of the rotisserie fork is coaxially aligned with a longitudinal axis of the rotisserie spit, (3) sliding the rotisserie fork along the longitudinal axis of the rotisserie spit until the rotisserie fork reaches a desired position (e.g., typically a centralized position) on the rotisserie spit, and (4) replacing the rotisserie spit in its supported position on and/or within the cookbox of the grill. In some instances, the performance of steps (1) and (4) requires detaching and/or attaching one end of the rotisserie spit to a motor of a rotisserie cooking system of the grill, whereby the motor is configured to rotate the rotisserie spit (e.g., about the longitudinal axis of the rotisserie spit) within the cookbox of the grill. Detaching and/or removing such known rotisserie forks from a rotisserie spit involves a reversal of the aforementioned four-step process.

### BRIEF DESCRIPTION OF THE DRAWINGS

FIG. 1 is a first perspective view of an example rotisserie fork set constructed in accordance with teachings of this disclosure.

FIG. 2 is a second perspective view of the rotisserie fork set of FIG. 1.

FIG. 3 is a front view of the rotisserie fork set of FIGS. 1 and 2.

FIG. 4 is a rear view of the rotisserie fork set of FIGS. 1-3.

FIG. 5 is a right side view of the rotisserie fork set of FIGS. 1-4.

FIG. 6 is a left side view of the rotisserie fork set of FIGS. 1-5.

FIG. 7 is a top view of the rotisserie fork set of FIGS. 1-6.

FIG. 8 is a bottom view of the rotisserie fork set of FIGS. 1-7.

FIG. 9 is a first perspective view of the first fork of FIGS. 1-8.

FIG. 10 is a second perspective view of the first fork of FIGS. 1-9.

FIG. 11 is a right side view of the first fork of FIGS. 1-10.

FIG. 12 is a left side view of the first fork of FIGS. 1-11.

FIG. 13 is a front view of the first fork of FIGS. 1-12.

FIG. 14 is a rear view of the first fork of FIGS. 1-13.

FIG. 15 is a top view of the first fork of FIGS. 1-14.

FIG. 16 is a bottom view of the first fork of FIGS. 1-15.

FIG. 17 is a right side view of the first fork of FIGS. 1-16, with the first fastener of FIGS. 1-8 shown in an example locked position, and with the first clip of FIGS. 1-8 shown in an example closed position.

FIG. 18 is a rear view of the first fork of FIGS. 1-17, with the first fastener of FIGS. 1-8 and 17 shown in the locked position of FIG. 17, and with the first clip of FIGS. 1-8 and 17 shown in the closed position of FIG. 17.

FIG. 19 is a right side view of the first fork of FIGS. 1-18, with the first fastener of FIGS. 1-8, 17, and 18 shown in an example unlocked position, and with the first clip of FIGS. 1-8, 17, and 18 shown in an example open position.

FIG. 20 is a rear view of the first fork of FIGS. 1-19, with the first fastener of FIGS. 1-8 and 17-19 shown in the unlocked position of FIG. 19, and with the first clip of FIGS. 1-8 and 17-19 shown in the open position of FIG. 19.

FIG. 21 is a first perspective view of the second fork of FIGS. 1-8.

FIG. 22 is a second perspective view of the second fork of FIGS. 1-8 and 21.

FIG. 23 is a left side view of the second fork of FIGS. 1-8, 21 and 22.

FIG. 24 is a right side view of the second fork of FIGS. 1-8 and 21-23.

FIG. 25 is a front view of the second fork of FIGS. 1-8 and 21-24.

FIG. 26 is a rear view of the second fork of FIGS. 1-8 and 21-25.

FIG. 27 is a top view of the second fork of FIGS. 1-8 and 21-26.

FIG. 28 is a bottom view of the second fork of FIGS. 1-8 and 21-27.

FIG. 29 is a left side view of the second fork of FIGS. 1-8 and 21-28, with the second fastener of FIGS. 1-8 shown in an example locked position, and with the second clip of FIGS. 1-8 shown in an example closed position.

FIG. 30 is a rear view of the second fork of FIGS. 1-8 and 21-29, with the second fastener of FIGS. 1-8 and 29 shown in the locked position of FIG. 29, and with the second clip of FIGS. 1-8 and 29 shown in the closed position of FIG. 29.

FIG. 31 is a left side view of the second fork of FIGS. 1-8 and 21-30, with the second fastener of FIGS. 1-8, 29, and 30 shown in an example unlocked position, and with the second clip of FIGS. 1-8, 29, and 30 shown in an example open position.

FIG. 32 is a rear view of the second fork of FIGS. 1-8 and 21-31, with the second fastener of FIGS. 1-8 and 29-31 shown in the unlocked position of FIG. 31, and with the second clip of FIGS. 1-8 and 29-31 shown in the open position of FIG. 31.

FIG. 33 is a perspective view of an example rotisserie spit.

FIG. 34 is a perspective view of the rotisserie fork set of FIGS. 1-8 positioned for transverse loading onto the rotisserie spit of FIG. 33.

FIG. 35 is a right side view of the rotisserie fork set of FIGS. 1-8 and 34 positioned for transverse loading onto the rotisserie spit of FIGS. 33 and 34.

FIG. 36 is a top view of the rotisserie fork set of FIGS. 1-8, 34 and 35 positioned for transverse loading onto the rotisserie spit of FIGS. 33-35.

FIG. 37 is a perspective view of the rotisserie fork set of FIGS. 1-8 and 34-36 transversely loaded onto the rotisserie spit of FIGS. 33-36.

FIG. 38 is a right side view of the rotisserie fork set of FIGS. 1-8 and 34-37 transversely loaded onto the rotisserie spit of FIGS. 33-37.

FIG. 39 is a top view of the rotisserie fork set of FIGS. 1-8 and 34-38 transversely loaded onto the rotisserie spit of FIGS. 33-38.

FIG. 40 is a perspective view of a cookbox of a grill, showing the rotisserie fork set of FIGS. 1-8 and 34-39 positioned for transverse loading onto the rotisserie spit of FIGS. 33-39.

FIG. 41 is a perspective view of the cookbox of the grill of FIG. 40, showing the rotisserie fork set of FIGS. 1-8 and 34-40 transversely loaded onto the rotisserie spit of FIGS. 33-40.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Known rotisserie forks are configured to be attached to a rotisserie spit by (1) removing the rotisserie spit from its supported position on and/or within a cookbox of a grill, (2) loading the rotisserie fork onto an end of the rotisserie spit such that a lateral passageway of a mounting bracket of the rotisserie fork is coaxially aligned with a longitudinal axis of the rotisserie spit, (3) sliding the rotisserie fork along the longitudinal axis of the rotisserie spit until the rotisserie fork reaches a desired position (e.g., typically a centralized position) on the rotisserie spit, and (4) replacing the rotisserie spit in its supported position on and/or within the cookbox of the grill. In some instances, the performance of steps (1) and (4) is further complicated by requiring that one end of the rotisserie spit be detached and/or attached to a motor of a rotisserie cooking system of the grill, whereby the motor is configured to rotate the rotisserie spit (e.g., about the longitudinal axis of the rotisserie spit) within the cookbox of the grill. Detaching and/or removing such known rotisserie forks from a rotisserie spit involves a reversal of the aforementioned four-step process. Performing such a four-step process can often be difficult for an end user and, at a minimum, is undesirably time consuming.

Unlike known rotisserie forks that are configured to be longitudinally loaded onto a rotisserie spit, example rotisserie forks disclosed herein are advantageously configured to be transversely loaded onto a rotisserie spit. By comparison to the above-described four-step process associated with longitudinally loading known rotisserie forks onto a rotisserie spit, example rotisserie forks disclosed herein can advantageously be transversely loaded onto (and transversely unloaded from) a rotisserie spit without removing the rotisserie spit from its supported position on and/or within a cookbox of a grill, without having to thread the rotisserie fork onto an end of the rotisserie spit, and without having to slide the rotisserie fork along a longitudinal axis of the rotisserie spit to a desired position. These advantages attributed to the transversely-loadable nature of the example rotisserie forks disclosed herein provide a user experience that is drastically improved relative to the user experience associated with known rotisserie forks that are only capable of being longitudinally loaded onto a rotisserie spit.

The above-identified features as well as other advantageous features of example transversely-loadable rotisserie forks as disclosed herein are further described below in connection with the figures of the application. As used herein, the term “configured” means sized, shaped, arranged, structured, oriented, positioned and/or located. For example, in the context of a first object configured to fit within a second object, the first object is sized, shaped, arranged, structured, oriented, positioned and/or located to fit within the second object. As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary. For example, a plurality of trees can circumscribe a field.

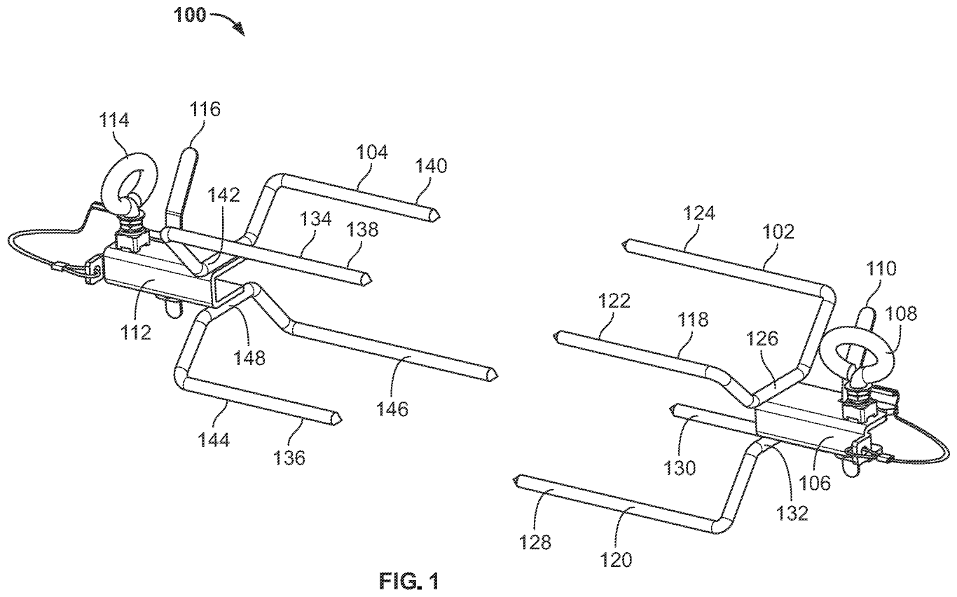

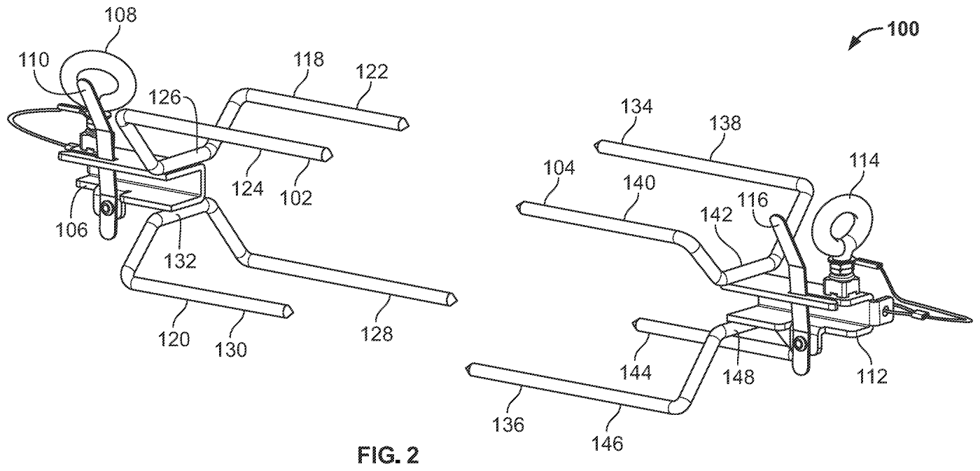

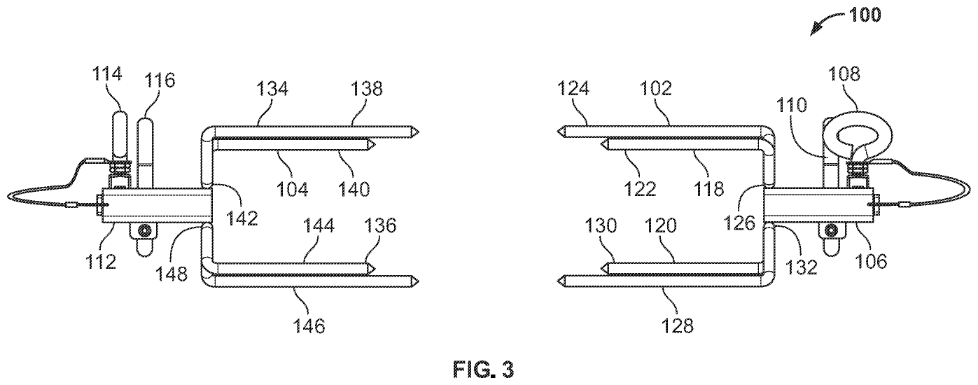

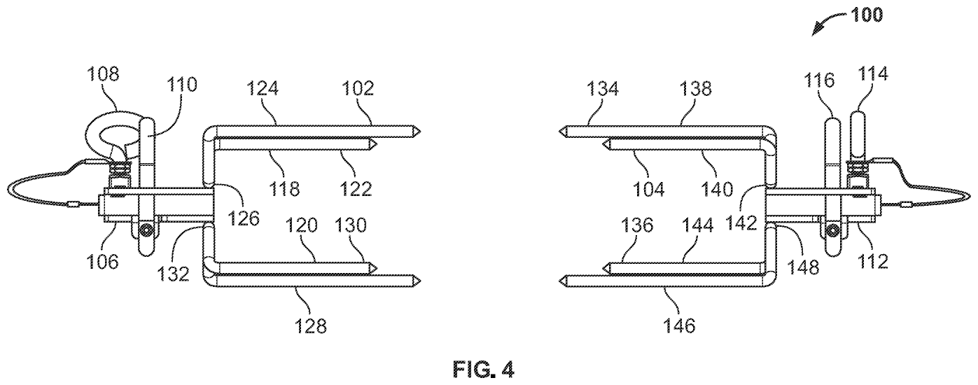

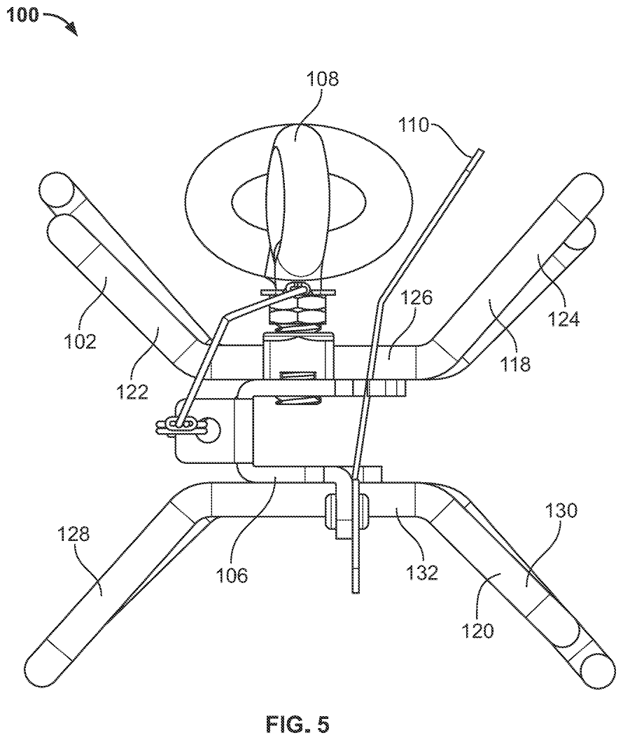

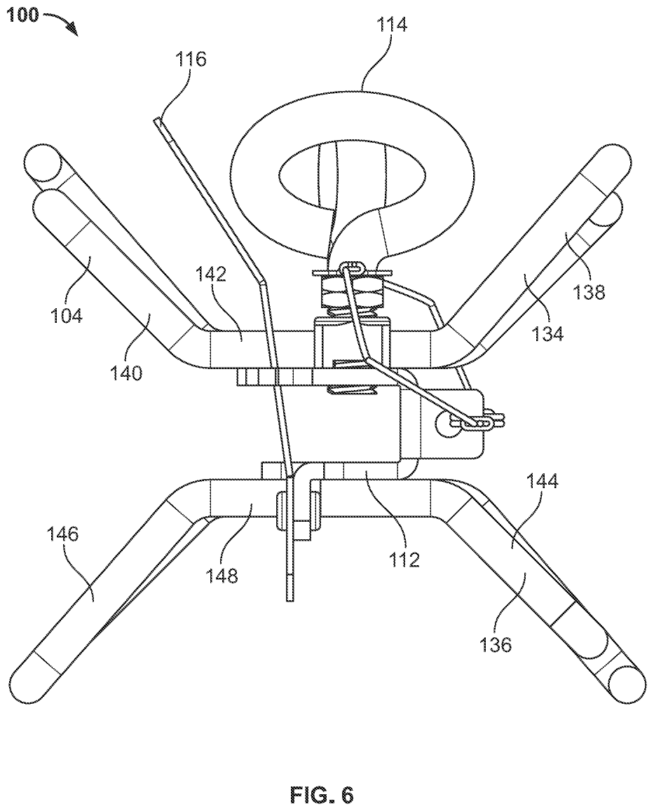

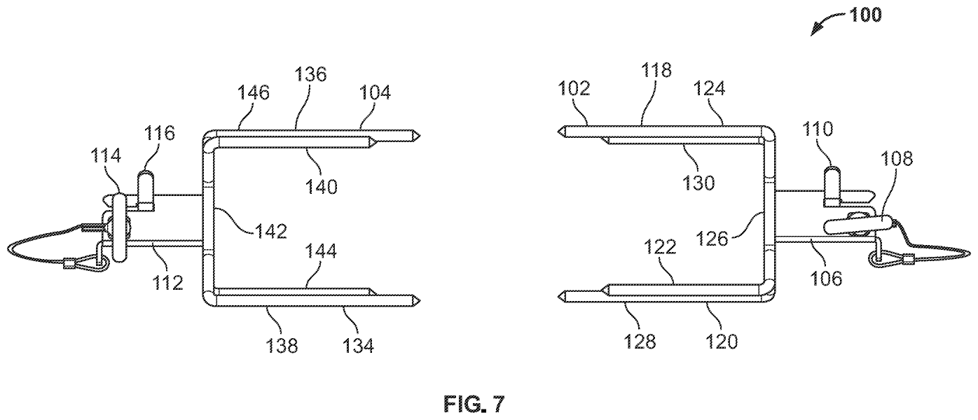

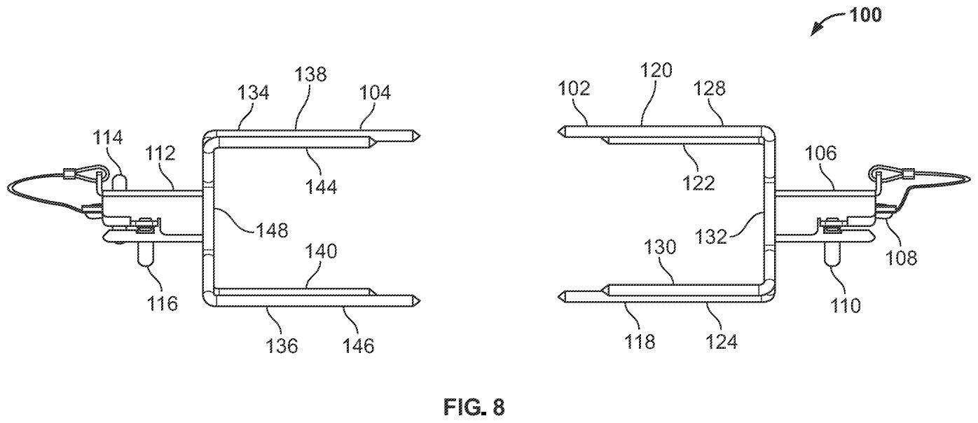

FIG. 1 is a first perspective view of an example rotisserie fork set 100 constructed in accordance with teachings of this disclosure. FIG. 2 is a second perspective view of the rotisserie fork set 100 of FIG. 1. FIG. 3 is a front view of the rotisserie fork set 100 of FIGS. 1 and 2. FIG. 4 is a rear view of the rotisserie fork set 100 of FIGS. 1-3. FIG. 5 is a right side view of the rotisserie fork set 100 of FIGS. 1-4. FIG. 6 is a left side view of the rotisserie fork set 100 of FIGS. 1-5. FIG. 7 is a top view of the rotisserie fork set 100 of FIGS. 1-6. FIG. 8 is a bottom view of the rotisserie fork set 100 of FIGS. 1-7.

In the illustrated example of FIGS. 1-8, the rotisserie fork set 100 includes an example first fork 102 (e.g., a right, leftward-facing fork) and an example second fork 104 (e.g., a left, rightward-facing fork). The second fork 104 is configured to be laterally (e.g., axially) spaced apart from the first fork 102 when the first fork 102 and the second fork 104 are respectively in a use position (e.g., when the first fork 102 and the second fork 104 are respectively attached to a rotisserie spit). The first fork 102 of the rotisserie fork set 100 of FIGS. 1-8 includes an example first mounting bracket 106, an example first fastener 108, and an example first clip 110, with the first mounting bracket 106, the first fastener 108, and the first clip 110 being respectively configured to facilitate transverse loading of the first fork 102 onto a rotisserie spit. The second fork 104 of the rotisserie fork set 100 of FIGS. 1-8 includes an example second mounting bracket 112, an example second fastener 114, and an example second clip 116, with the second mounting bracket 112, the second fastener 114, and the second clip 116 being respectively configured to facilitate transverse loading of the second fork 104 onto a rotisserie spit.

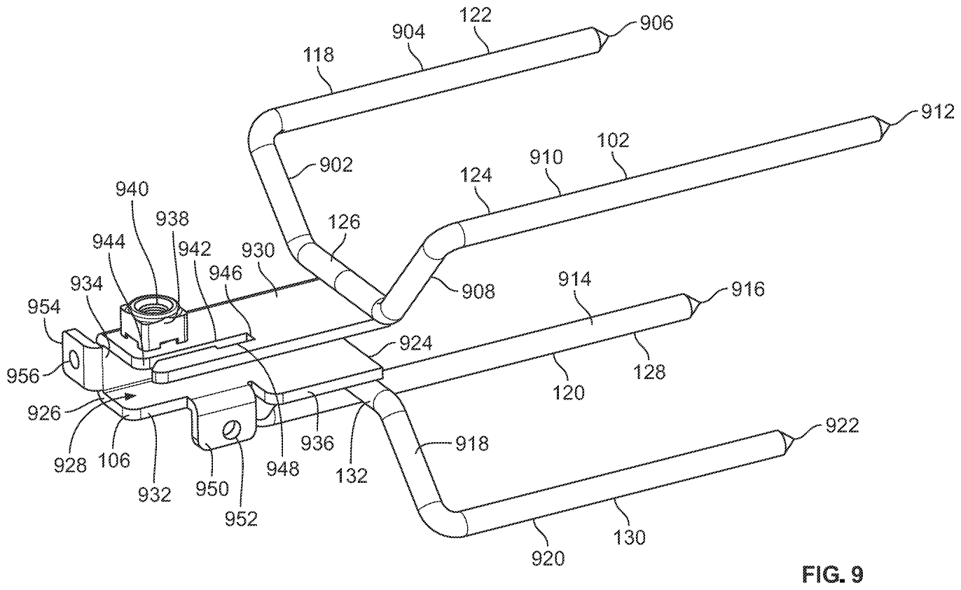

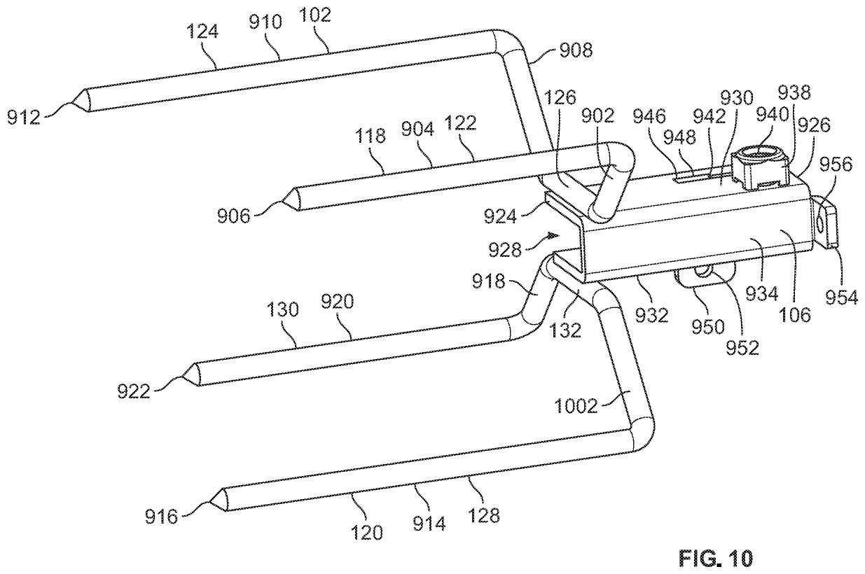

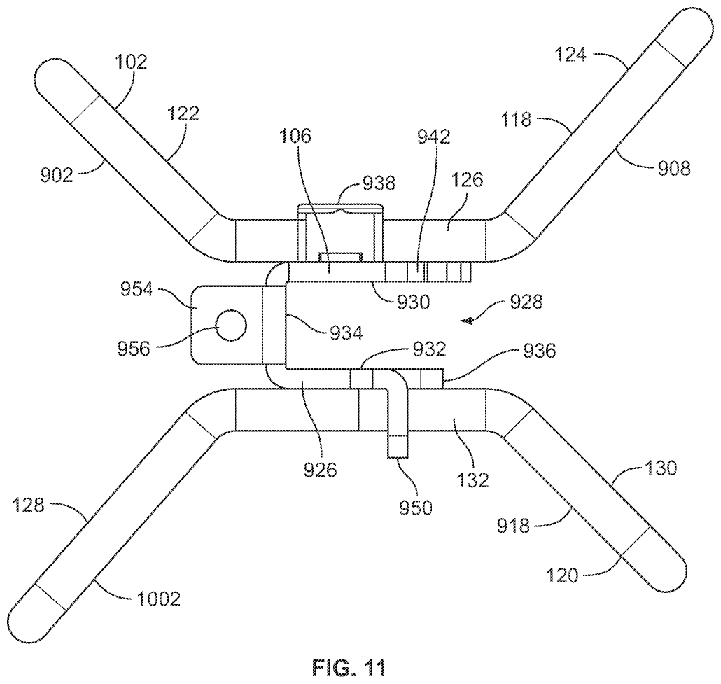

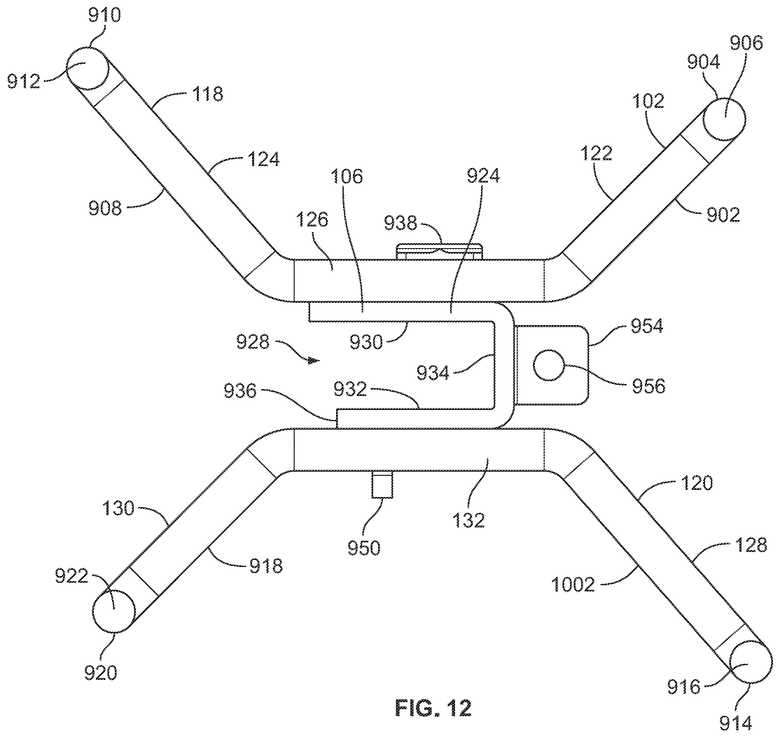

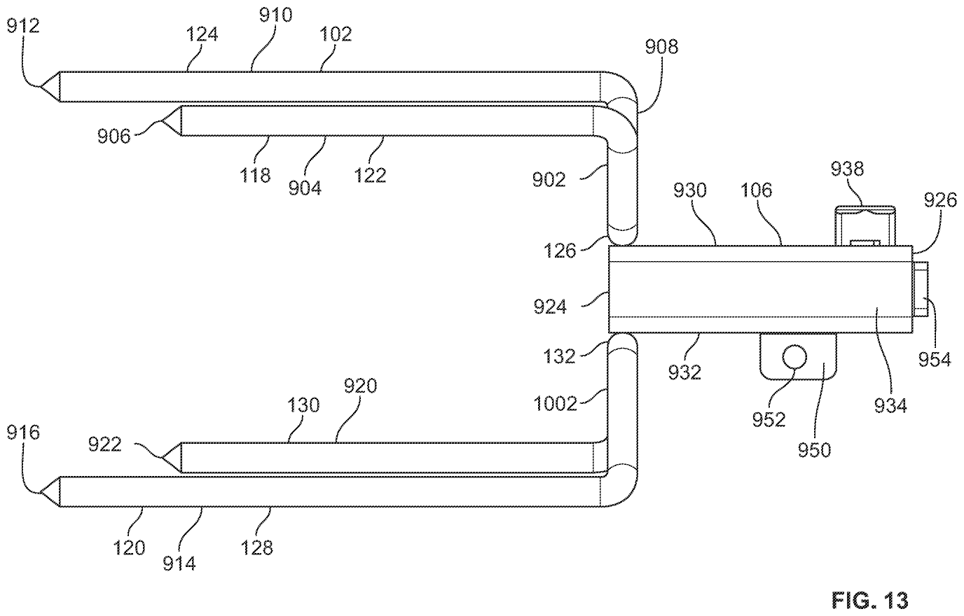

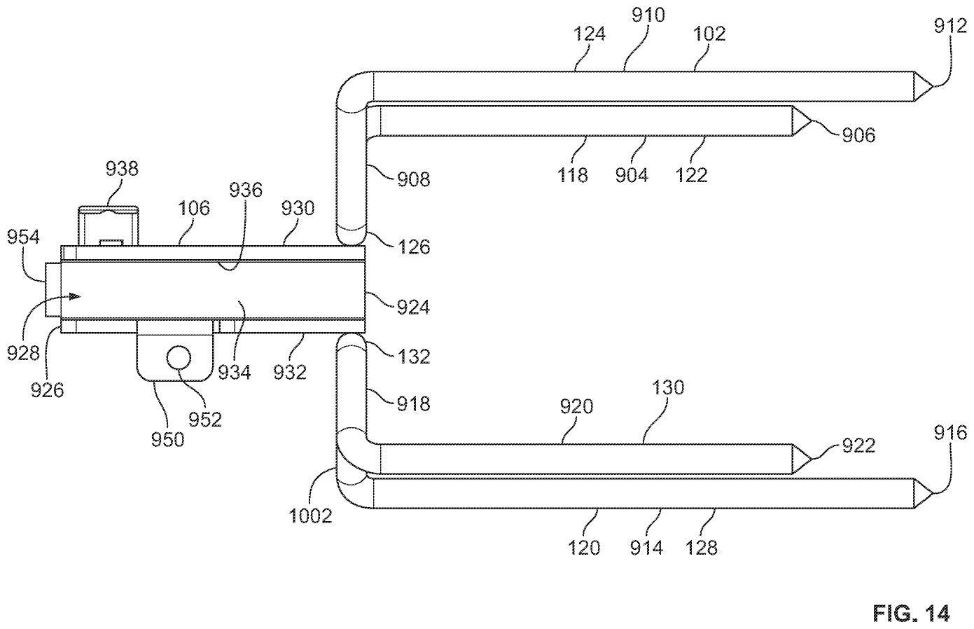

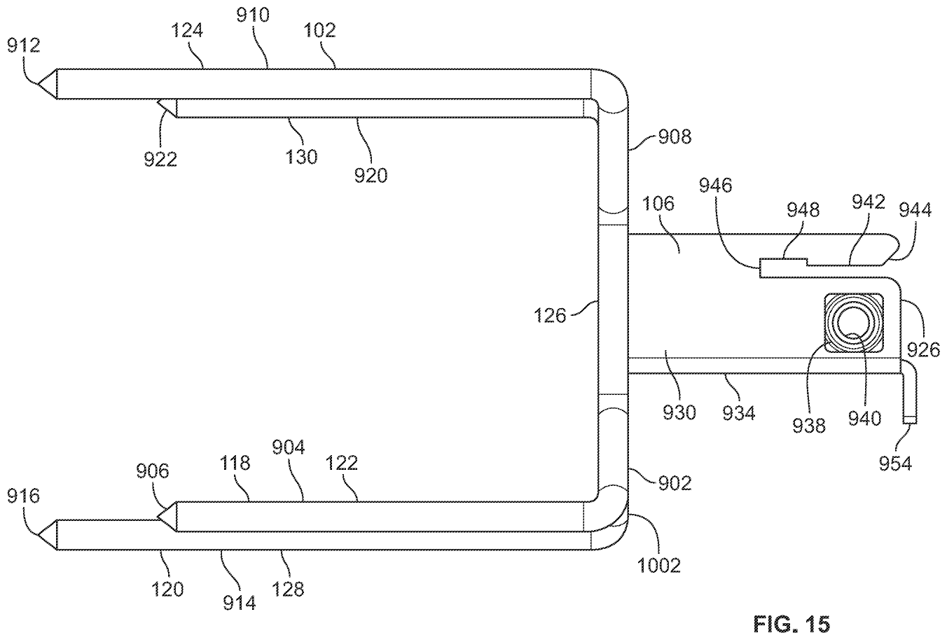

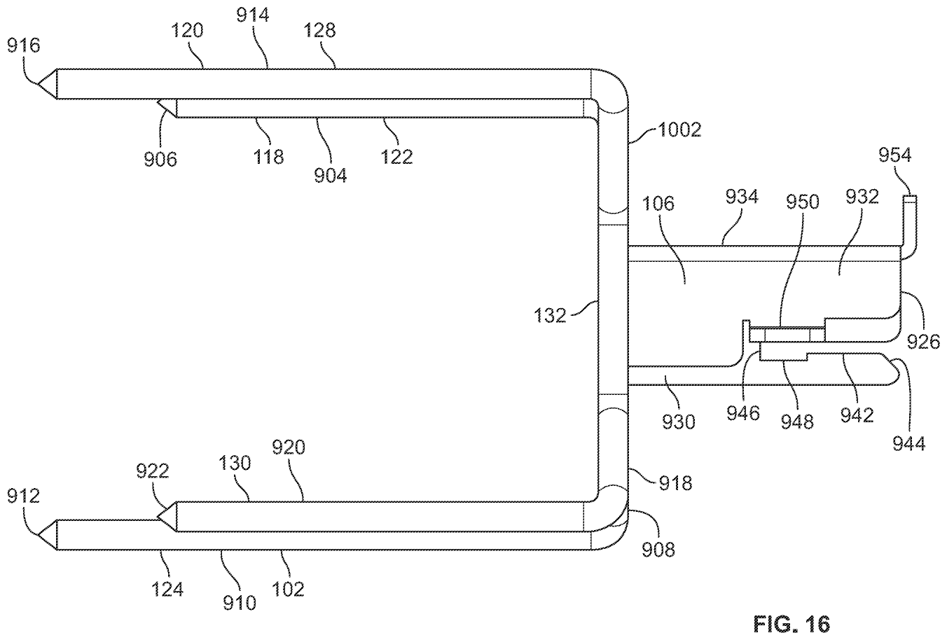

Additional views of the first fork 102 of the rotisserie fork set 100 of FIGS. 1-8 are shown in FIGS. 9-16. In this regard, FIG. 9 is a first perspective view of the first fork 102 of FIGS. 1-8. FIG. 10 is a second perspective view of the first fork 102 of FIGS. 1-9. FIG. 11 is a right side view of the first fork 102 of FIGS. 1-10. FIG. 12 is a left side view of the first fork 102 of FIGS. 1-11. FIG. 13 is a front view of the first fork 102 of FIGS. 1-12. FIG. 14 is a rear view of the first fork 102 of FIGS. 1-13. FIG. 15 is a top view of the first fork 102 of FIGS. 1-14. FIG. 16 is a bottom view of the first fork 102 of FIGS. 1-15. In the illustrated views of FIGS. 9-16, the first fastener 108 and the first clip 110 associated with the first fork 102 have been omitted for clarity.

The first fork 102 of FIGS. 1-16 includes an example upper prong unit 118 and an example lower prong unit 120 spaced apart from the upper prong unit 118. In the illustrated example of FIGS. 1-16, the upper prong unit 118 of the first fork 102 is generally located above the first mounting bracket 106 of the first fork 102, and the lower prong unit 120 of the first fork 102 is generally located below the first mounting bracket 106 of the first fork 102.

The upper prong unit 118 of the first fork 102 of FIGS. 1-16 includes an example first upper prong 122, an example second upper prong 124, and an example upper base 126. The upper base 126 is located between the first upper prong 122 and the second upper prong 124, with the upper base 126 coupling the upper prong unit 118 of the first fork 102 to an upper wall of the first mounting bracket 106 of the first fork 102, as further described below. Although the upper prong unit 118 of the first fork 102 is shown in FIGS. 1-16 as having two prongs, the upper prong unit 118 can in other examples have a different number (e.g., 1, 3, 4, etc.) of prongs.

In the illustrated example of FIGS. 1-16, the first upper prong 122 of the upper prong unit 118 includes an example radial segment 902 and an example axial segment 904. The radial segment 902 of the first upper prong 122 is coupled to (e.g., integrally formed with) and extends radially (e.g., forwardly and upwardly) away from the upper base 126 of the upper prong unit 118. The axial segment 904 of the first upper prong 122 is coupled to (e.g., integrally formed with) and extends laterally (e.g., axially) away from the radial segment 902 of the first upper prong 122. The axial segment 904 of the first upper prong 122 includes an example free end 906 having a spiked tip configured to pierce one or more item(s) of food to facilitate loading the item(s) of food onto the first upper prong 122 and/or, more generally, onto the first fork 102. In the illustrated example of FIGS. 1-16, the first upper prong 122 has an L-shaped profile. In the other examples, the first upper prong 122 can alternatively have a profile that differs from the L-shaped profile shown in FIGS. 1-16.

In the illustrated example of FIGS. 1-16, the second upper prong 124 of the upper prong unit 118 includes an example radial segment 908 and an example axial segment 910. The radial segment 908 of the second upper prong 124 is coupled to (e.g., integrally formed with) and extends radially (e.g., rearwardly and upwardly) away from the upper base 126 of the upper prong unit 118. The axial segment 910 of the second upper prong 124 is coupled to (e.g., integrally formed with) and extends laterally (e.g., axially) away from the radial segment 908 of the second upper prong 124. The axial segment 910 of the second upper prong 124 includes an example free end 912 having a spiked tip configured to pierce one or more item(s) of food to facilitate loading the item(s) of food onto the second upper prong 124 and/or, more generally, onto the first fork 102. In the illustrated example of FIGS. 1-16, the second upper prong 124 has an L-shaped profile. In the other examples, the second upper prong 124 can alternatively have a profile that differs from the L-shaped profile shown in FIGS. 1-16.

The lower prong unit 120 of the first fork 102 of FIGS. 1-16 includes an example first lower prong 128, an example second lower prong 130, and an example lower base 132. The lower base 132 is located between the first lower prong 128 and the second lower prong 130, with the lower base 132 coupling the lower prong unit 120 of the first fork 102 to a lower wall of the first mounting bracket 106 of the first fork 102, as further described below. Although the lower prong unit 120 of the first fork 102 is shown in FIGS. 1-16 as having two prongs, the lower prong unit 120 can in other examples have a different number (e.g., 1, 3, 4, etc.) of prongs. Furthermore, although the upper prong unit 118 and the lower prong unit 120 of the first fork 102 are shown in FIGS. 1-16 as having a matching number of prongs (e.g., two each), the number of prongs of the lower prong unit 120 of the first fork 102 can in other example differ from the number of prongs of the upper prong unit 118 of the first fork 102.

In the illustrated example of FIGS. 1-16, the first lower prong 128 of the lower prong unit 120 includes an example radial segment 1002 and an example axial segment 914. The radial segment 1002 of the first lower prong 128 is coupled to (e.g., integrally formed with) and extends radially (e.g., forwardly and downwardly) away from the lower base 132 of the lower prong unit 120. The axial segment 914 of the first lower prong 128 is coupled to (e.g., integrally formed with) and extends laterally (e.g., axially) away from the radial segment 1002 of the first lower prong 128. The axial segment 914 of the first lower prong 128 includes an example free end 916 having a spiked tip configured to pierce one or more item(s) of food to facilitate loading the item(s) of food onto the first lower prong 128 and/or, more generally, onto the first fork 102. In the illustrated example of FIGS. 1-16, the first lower prong 128 has an L-shaped profile. In the other examples, the first lower prong 128 can alternatively have a profile that differs from the L-shaped profile shown in FIGS. 1-16.

In the illustrated example of FIGS. 1-16, the second lower prong 130 of the lower prong unit 120 includes an example radial segment 918 and an example axial segment 920. The radial segment 918 of the second lower prong 130 is coupled to (e.g., integrally formed with) and extends radially (e.g., rearwardly and downwardly) away from the lower base 132 of the lower prong unit 120. The axial segment 920 of the second lower prong 130 is coupled to (e.g., integrally formed with) and extends laterally (e.g., axially) away from the radial segment 918 of the second lower prong 130. The axial segment 920 of the second lower prong 130 includes an example free end 922 having a spiked tip configured to pierce one or more item(s) of food to facilitate loading the item(s) of food onto the second lower prong 130 and/or, more generally, onto the first fork 102. In the illustrated example of FIGS. 1-16, the second lower prong 130 has an L-shaped profile. In the other examples, the second lower prong 130 can alternatively have a profile that differs from the L-shaped profile shown in FIGS. 1-16.

The first mounting bracket 106 of the first fork 102 of FIGS. 1-16 extends laterally (e.g., axially) away from the upper prong unit 118 and the lower prong unit 120 of the first fork 102. In the illustrated example of FIGS. 1-16, the first mounting bracket 106 is oriented and/or positioned orthogonally relative to the upper base 126 of the upper prong unit 118 and/or relative to the lower base 132 of the lower prong unit 120. In other examples, the first mounting bracket 106 can alternatively be oriented and/or positioned non-orthogonally relative to the upper base 126 of the upper prong unit 118 and/or relative to the lower base 132 of the lower prong unit 120. In the illustrated example of FIGS. 1-16, the first mounting bracket 106 is integrally formed with (e.g., mechanically inseparable from) the upper base 126 of the upper prong unit 118 and the lower base 132 of the lower prong unit 120. In other examples, the first mounting bracket 106 can alternatively be removably coupled to the upper base 126 of the upper prong unit 118 and/or the lower base 132 of the lower prong unit 120 via one or more fastener(s).

The first mounting bracket 106 of FIGS. 1-16 includes an example first end 924 positioned adjacent (e.g., in contact with) the upper base 126 of the upper prong unit 118 and/or the lower base 132 of the lower prong unit 120, and an example second end 926 (e.g., a free end) located opposite the first end 924. The first mounting bracket 106 defines an example mounting channel 928 that extends laterally (e.g., in a right-to-left direction) from the second end 926 of the first mounting bracket 106 through to the first end 924 of the first mounting bracket 106, thereby providing a lateral (e.g., axial) passageway through the first mounting bracket 106. As shown in FIGS. 9-16, the mounting channel 928 of the first mounting bracket 106 includes an example upper wall 930, an example lower wall 932 located opposite the upper wall 930, an example front wall 934 extending between the upper wall 930 and the lower wall 932, and an example rear opening 936 located opposite the front wall 934 and extending between the upper wall 930 and the lower wall 932.

In the illustrated example of FIGS. 1-16, the upper wall 930, the lower wall 932, the front wall 934, and the rear opening 936 of the mounting channel 928 respectively extend from the first end 924 of the first mounting bracket 106 to the second end 926 of the first mounting bracket 106. In other examples, the upper wall 930, the lower wall 932, and/or the front wall 934 can alternatively extend only partially between the first end 924 of the first mounting bracket 106 and the second end 926 of the first mounting bracket 106. In the illustrated example of FIGS. 1-16, the upper wall 930, the lower wall 932, and the front wall 934 of the mounting channel 928 are respectively formed as planar (e.g., linear) walls. In other examples, one or more of the upper wall 930, the lower wall 932, and/or the front wall 934 of the mounting channel 928 can alternatively be formed as a curved (e.g., non-linear) wall. In the illustrated example of FIGS. 1-16, the mounting channel 928 has a C-shaped profile. In the other examples, the mounting channel 928 can alternatively have a profile that differs from the C-shaped profile shown in FIGS. 1-16.

The upper wall 930, the lower wall 932, the front wall 934, and the rear opening 936 of the mounting channel 928 are collectively configured to receive and/or accommodate a rotisserie spit. In this regard, the mounting channel 928 of the first mounting bracket 106 is constructed as a rearwardly-facing and/or rearwardly-opening channel that is advantageously configured to receive a rotisserie spit via the rear opening 936 of the mounting channel 928. The first mounting bracket 106 can accordingly be loaded onto and/or unloaded from a rotisserie spit in a transverse direction (e.g., relative to a longitudinal axis of the rotisserie spit) via the rear opening 936 of the mounting channel 928, as further described below.

The first mounting bracket 106 of FIGS. 1-16 further includes an example nut 938 fixedly coupled (e.g., welded) to a topside of the upper wall 930 of the first mounting bracket 106. In the illustrated example of FIGS. 1-16, the nut 938 of the first mounting bracket 106 includes an example threaded opening 940 that is vertically aligned with (e.g., coaxially positioned relative to) an opening (e.g., a through hole) formed in and extending through the upper wall 930 of the first mounting bracket 106. The nut 938 is configured to threadedly receive and/or accommodate a threaded portion of a shaft of the first fastener 108 associated with the first mounting bracket 106, as further described below.

The first mounting bracket 106 of FIGS. 1-16 further includes an example slot 942 formed in and extending through the upper wall 930 of the first mounting bracket 106. In the illustrated example of FIGS. 1-16, the slot 942 includes an example first end 944 (e.g., an open end) and an example second end 946 (e.g., a closed end) located opposite the first end 944. The first end 944 of the slot 942 is configured to receive an engagement portion of the first clip 110 associated with the first mounting bracket 106, as further described below. In this regard, the first clip 110 is slidable and/or rotatable into and out of the first end 944 of the slot 942, and is further slidable and/or rotatable within the slot 942 between the first end 944 and the second end 946 of the slot 942. In the illustrated example of FIGS. 1-16, the second end 946 of the slot 942 includes an example expansion notch 948 that is configured to receive the engagement portion of the first clip 110 as the first clip 110 slides and/or rotates from the first end 944 to the second end 946 of the slot 942. The expansion notch 948 is further configured to function as a mechanical stop that restricts the engagement portion of the first clip 110 from inadvertently sliding and/or rotating from the second end 946 of the slot 942 back to the first end 944 of the slot 942 absent physical manipulation of the first clip 110 by a user. In other examples, the expansion notch 948 can instead be omitted from the slot 942.

The first mounting bracket 106 of FIGS. 1-16 further includes an example clip flange 950 that extends downwardly from the lower wall 932 of the first mounting bracket 106. In the illustrated example of FIGS. 1-16, the clip flange 950 is integrally formed with (e.g., mechanically inseparable from) the first mounting bracket 106. In other examples, the clip flange 950 can alternatively be removably coupled to the first mounting bracket 106 via one or more fastener(s). The clip flange 950 includes an example opening 952 that facilitates the attachment of the first clip 110 to the first mounting bracket 106 and/or, more generally, to the first fork 102, as further described below.

The first mounting bracket 106 of FIGS. 1-16 further includes an example cable flange 954 that extends forwardly from the front wall 934 of the first mounting bracket 106. In the illustrated example of FIGS. 1-16, the cable flange 954 is integrally formed with (e.g., mechanically inseparable from) the first mounting bracket 106. In other examples, the cable flange 954 can alternatively be removably coupled to the first mounting bracket 106 via one or more fastener(s). The cable flange 954 includes an example opening 956 that facilitates the attachment of a first end of a metal cable to the cable flange 954. A second end of the metal cable located opposite the first end of the metal cable can be attached to a portion (e.g., a shaft or a looped portion) of the first fastener 108, as shown in FIGS. 1-8. Attachment of the first fastener 108 to the cable flange 954 via the metal cable advantageously tethers the first fastener 108 to the first mounting bracket 106 so as to prevent the first fastener 108 from becoming completely separated from the first mounting bracket 106 and/or, more generally, from the first fork 102 when the first fastener 108 is not threadedly coupled to the nut 938 of the first mounting bracket 106.

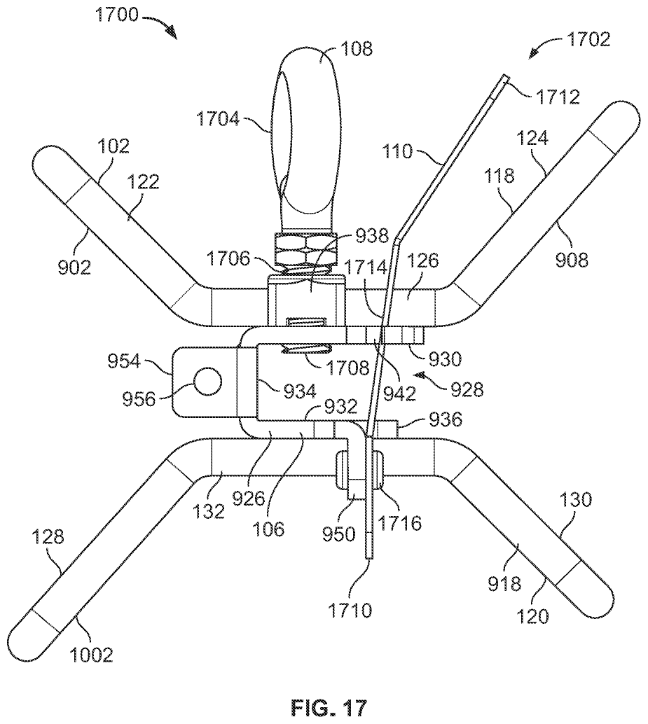

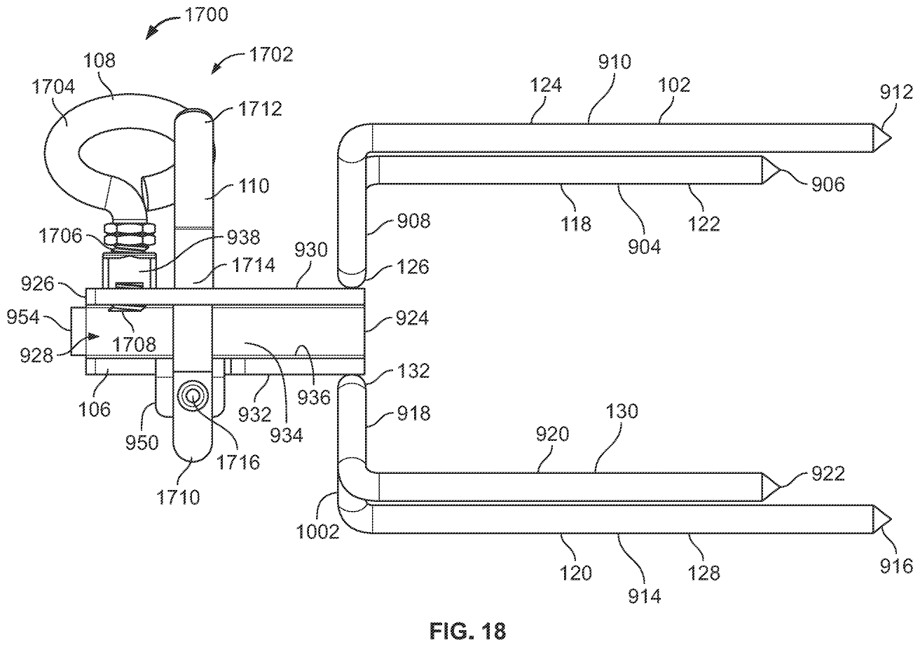

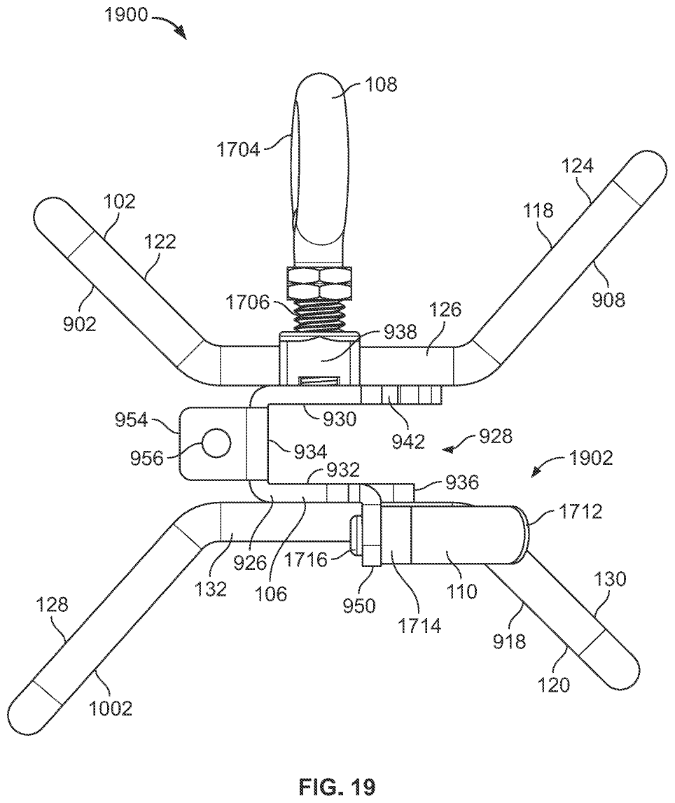

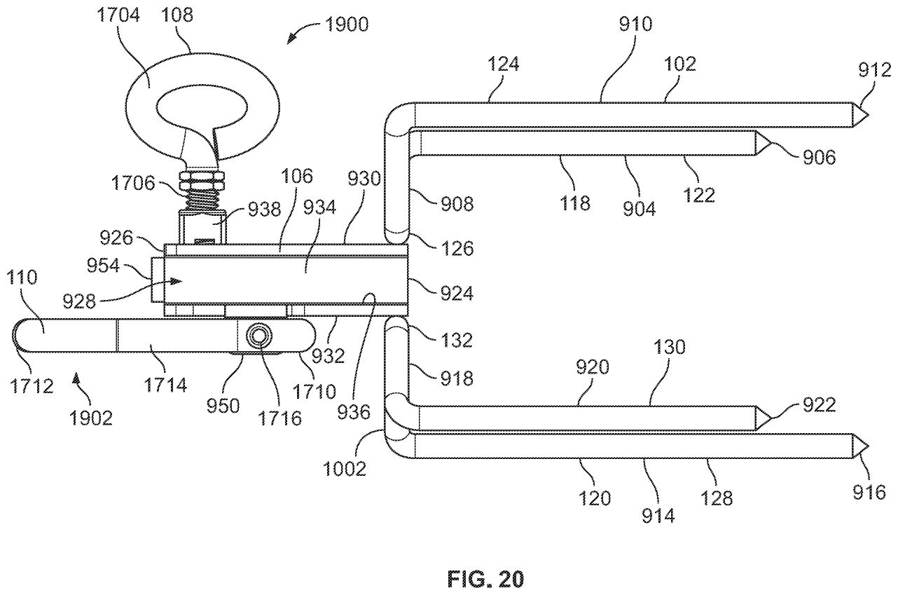

FIG. 17 is a right side view of the first fork 102 of FIGS. 1-16, with the first fastener 108 of FIGS. 1-8 shown in an example locked position 1700, and with the first clip 110 of FIGS. 1-8 shown in an example closed position 1702. FIG. 18 is a rear view of the first fork 102 of FIGS. 1-17, with the first fastener 108 of FIGS. 1-8 and 17 shown in the locked position 1700 of FIG. 17, and with the first clip 110 of FIGS. 1-8 and 17 shown in the closed position 1702 of FIG. 17. FIG. 19 is a right side view of the first fork 102 of FIGS. 1-18, with the first fastener 108 of FIGS. 1-8, 17, and 18 shown in an example unlocked position 1900, and with the first clip 110 of FIGS. 1-8, 17, and 18 shown in an example open position 1902. FIG. 20 is a rear view of the first fork 102 of FIGS. 1-19, with the first fastener 108 of FIGS. 1-8 and 17-19 shown in the unlocked position 1900 of FIG. 19, and with the first clip 110 of FIGS. 1-8 and 17-19 shown in the open position 1902 of FIG. 19.

In the illustrated example of FIGS. 1-8 and 17-20, the first fastener 108 is constructed as an eyebolt having an example looped portion 1704 and an example shaft 1706 extending from the looped portion 1704. The shaft 1706 of the first fastener 108 includes an example free end 1708 located opposite the looped portion 1704 of the first fastener 108. In the illustrated example of FIGS. 1-8 and 17-20, the shaft 1706 of the first fastener 108 is threaded along a substantial entirety of its length. In other examples, the shaft 1706 of the first fastener 108 can alternatively be threaded along only a portion of the length of the shaft 1706. Although the first fastener 108 of the first fork 102 of FIGS. 1-8 and 17-20 is constructed as an eyebolt, the first fastener 108 can alternatively be constructed as any type of known fastener having a threaded shaft (e.g., a bolt, a screw, etc.).

The shaft 1706 of the first fastener 108 of FIGS. 1-8 and 17-20 is configured to be threadedly received in the threaded opening 940 of the nut 938 of the first mounting bracket 106 such that the shaft 1706 and/or, more generally, the first fastener 108 is movable between the locked position 1700 shown in FIGS. 17 and 18 and the unlocked position 1900 shown in FIGS. 19 and 20. In this regard, the first fastener 108 can be threadedly coupled to the threaded opening 940 of the nut 938 of the first mounting bracket 106 by placing the free end 1708 of the shaft 1706 into the threaded opening 940 of the nut 938, and then rotating the first fastener 108 (e.g., in a clockwise direction) so as to engage the threaded portion of the shaft 1706 with the threaded opening 940 of the nut 938. As shown in FIGS. 17 and 18, the free end 1708 of the shaft 1706 of the first fastener 108 partially blocks, obstructs, and/or otherwise interferes with an upper aspect of a forward portion of the mounting channel 928 of the first mounting bracket 106 when the first fastener 108 is positioned in the locked position 1700. Conversely, as shown in FIGS. 19 and 20, the free end 1708 of the shaft 1706 of the first fastener 108 does not block, obstruct, and/or otherwise interfere with any aspect of the forward portion of the mounting channel 928 of the first mounting bracket 106 when the first fastener 108 is positioned in the unlocked position 1900.

In the illustrated example of FIGS. 17-20, the first fastener 108 is movable from the locked position 1700 to the unlocked position 1900 by rotating the first fastener 108 in a counter-clockwise direction, and is conversely movable from the unlocked position 1900 to the locked position 1700 by rotating the first fastener 108 in a clockwise direction. In other examples, the first fastener 108 can instead be movable from the locked position 1700 to the unlocked position 1900 by rotating the first fastener 108 in a clockwise direction, and can conversely be movable from the unlocked position 1900 to the locked position 1700 by rotating the first fastener 108 in a counter-clockwise direction.

As described in greater detail below, the first fastener 108 is to be removed from the locked position 1700 of FIGS. 17 and 18 prior to the first mounting bracket 106 being transversely loaded onto a rotisserie spit. In this regard, the first fastener 108 will typically be unthreaded from the locked position 1700 of FIGS. 17 and 18 to the unlocked position 1900 of FIGS. 19 and 20 such that the free end 1708 of the shaft 1706 of the first fastener 108 is not blocking any aspect of the forward portion of the mounting channel 928 of the first mounting bracket 106 in preparation of the first mounting bracket 106 being transversely loaded onto the rotisserie spit. Subsequent to the first mounting bracket 106 being transversely loaded onto the rotisserie spit via the rear opening 936 of the mounting channel 928 of the first mounting bracket 106, the first fastener 108 can thereafter be moved from the unlocked position 1900 of FIGS. 19 and 20 to the locked position 1700 of FIGS. 17 and 18 to securely couple the first mounting bracket 106 and/or, more generally, the first fork 102 to the rotisserie spit.

When the first fastener 108 is placed in the locked position 1700, the free end 1708 of the shaft 1706 of the first fastener 108 extends into the mounting channel 928 of the first mounting bracket 106 so as to engage a rotisserie spit located therein. The engagement between the free end 1708 of the shaft 1706 of the first fastener 108 and the rotisserie spit forces the rotisserie spit into pressurized and/or forceable contact with the lower wall 932 of the mounting channel 928, thereby securely coupling the first mounting bracket 106 and/or, more generally, the first fork 102 to the rotisserie spit. The first mounting bracket 106 and/or, more generally, the first fork 102 can conversely be transversely unloaded from the rotisserie spit in response to the first fastener 108 being unthreaded from the locked position 1700 of FIGS. 17 and 18 to the unlocked position 1900 of FIGS. 19 and 20 such that the free end 1708 of the shaft 1706 of the first fastener 108 is no longer contacting the rotisserie spit, and/or such that the free end 1708 of the shaft 1706 of the first fastener 108 is no longer blocking any aspect of the forward portion of the mounting channel 928 of the first mounting bracket 106 that would interfere with the rotisserie spit being removed therefrom.

In the illustrated example of FIGS. 1-8 and 17-20, the first clip 110 is constructed as a thin, semi-flexible rod having an example first end 1710, an example second end 1712 located opposite the first end 1710, and an example engagement portion 1714 located between the first end 1710 and the second end 1712. A portion of the first clip 110 located proximate the first end 1710 is configured to be pivotably coupled to the clip flange 950 of the first mounting bracket 106 of the first fork 102 such that the first clip 110 is rotatable relative to the first mounting bracket 106, and such that the engagement portion 1714 of the first clip 110 is receivable and/or movable within the slot 942 of the first mounting bracket 106. For example, as shown in FIGS. 17-20, the first clip 110 is pivotably coupled to the clip flange 950 of the first mounting bracket 106 of the first fork 102 via an example rivet 1716 located proximate the first end 1710 of the first clip 110, with the rivet 1716 extending through an opening formed in the first clip 110 and further extending through the opening 952 formed in the clip flange 950.

In the illustrated example of FIGS. 17-20, the engagement portion 1714 of the first clip 110 is movable between the closed position 1702 shown in FIGS. 17 and 18 and the open position 1902 shown in FIGS. 19 and 20. In this regard, the first clip 110 can be moved between the closed position 1702 and the open position 1902 by physically manipulating the second end 1712 of the first clip 110 so as to cause the engagement portion 1714 of the first clip 110 to rotate and/or pivot relative to the slot 942 of the first mounting bracket 106. As shown in FIGS. 17 and 18, the engagement portion 1714 of the first clip 110 blocks, obstructs, and/or otherwise interferes with a rearward portion of the mounting channel 928 of the first mounting bracket 106 when the first clip 110 is positioned in the closed position 1702. Conversely, as shown in FIGS. 19 and 20, the engagement portion 1714 of the first clip 110 does not block, obstruct, and/or otherwise interfere with any aspect of the rearward portion of the mounting channel 928 of the first mounting bracket 106 when the first clip 110 is positioned in the open position 1902.

As described in greater detail below, the first clip 110 is to be removed from the closed position 1702 of FIGS. 17 and 18 prior to the first mounting bracket 106 being transversely loaded onto a rotisserie spit. In this regard, the first clip 110 will typically be rotated from the closed position 1702 of FIGS. 17 and 18 to the open position 1902 of FIGS. 19 and 20 such that the engagement portion 1714 of the first clip 110 is not blocking any aspect of the rearward portion of the mounting channel 928 of the first mounting bracket 106 in preparation of the first mounting bracket 106 being transversely loaded onto the rotisserie spit. Subsequent to the first mounting bracket 106 being transversely loaded onto the rotisserie spit via the rear opening 936 of the mounting channel 928 of the first mounting bracket 106, the first clip 110 can thereafter be moved from the open position 1902 of FIGS. 19 and 20 to the closed position 1702 of FIGS. 17 and 18 to further couple the first mounting bracket 106 and/or, more generally, the first fork 102 to the rotisserie spit.

When the first clip 110 is placed in the closed position 1702, the engagement portion 1714 of the first clip 110 extends through and/or across a rearward portion of the mounting channel 928 (e.g., between the upper wall 930 and the lower wall 932) so as to transversely capture a rotisserie spit located within a forward portion of the mounting channel 928. The first clip 110 accordingly functions as a safety clip that prevents the first mounting bracket 106 and/or, more generally, the first fork 102 from inadvertently being transversely removed from the rotisserie spit. In this regard, the engagement portion 1714 of the first clip 110 is biased (e.g., rearwardly biased) into the expansion notch 948 of the slot 942 of the first mounting bracket 106 when the first clip 110 is placed in the closed position 1702, with the expansion notch 948 thereafter functioning as a mechanical stop that restricts the engagement portion 1714 of the first clip 110 from inadvertently sliding and/or rotating from the second end 946 of the slot 942 (e.g., out of the expansion notch 948) back to the first end 944 of the slot 942 absent physical manipulation of the first clip 110 by a user. Thus, the first mounting bracket 106 and/or, more generally, the first fork 102 can only be transversely unloaded from the rotisserie spit in response to the first clip 110 being slid and/or rotated from the closed position 1702 of FIGS. 17 and 18 to the open position 1902 of FIGS. 19 and 20, such that the engagement portion 1714 of the first clip 110 is moved out of the expansion notch 948 of the slot 942, and such that the engagement portion 1714 of the first clip 110 is no longer blocking any aspect of the rearward portion of the mounting channel 928 of the first mounting bracket 106 that would interfere with the rotisserie spit being removed therefrom.

As described above, the first clip 110 serves as a mechanical failsafe against inadvertent transverse removal of the first mounting bracket 106 and/or, more generally, the first fork 102 from the rotisserie spit. In this regard, it is the first fastener 108, rather than the first clip 110, that securely couples the first mounting bracket 106 and/or, more generally, the first fork 102 to the rotisserie spit. Thus, in other examples, the first clip 110 (as well as the associated slot 942 and the associated clip flange 950) can be omitted from the first mounting bracket 106 and/or, more generally, the first fork 102 without negatively impacting the capability of securely coupling the first mounting bracket 106 and/or, more generally, the first fork 102 to the rotisserie spit.

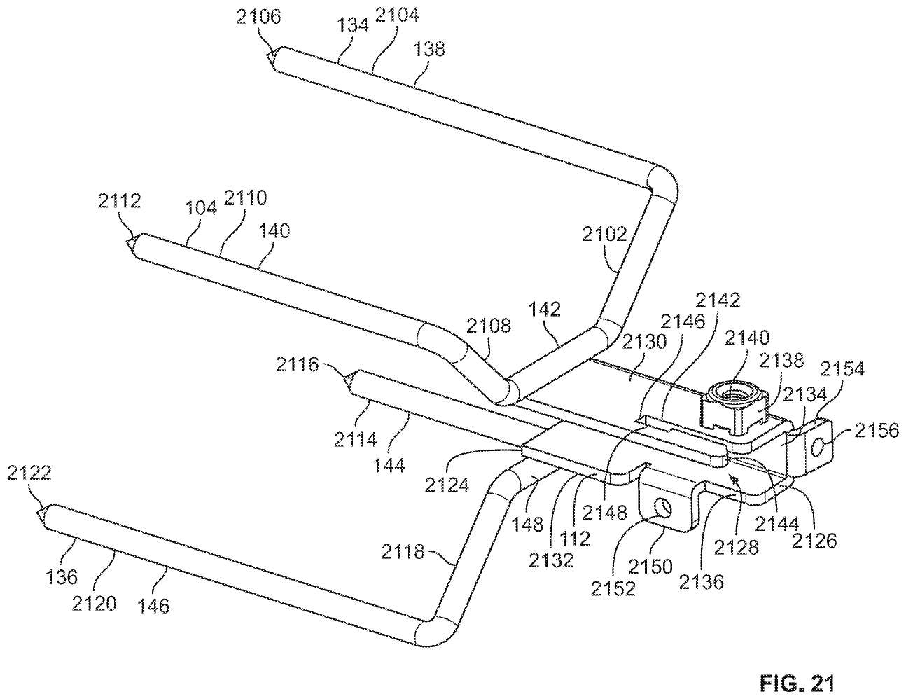

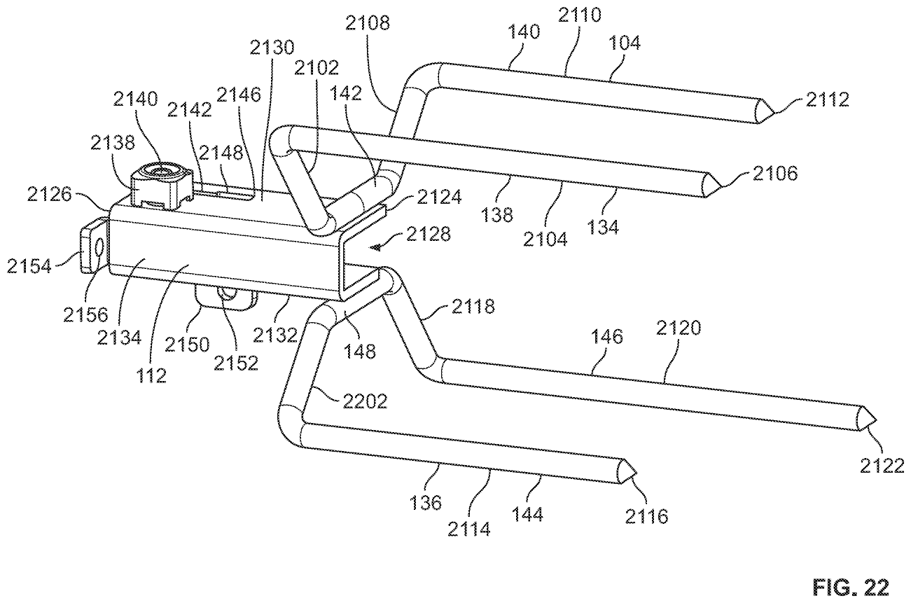

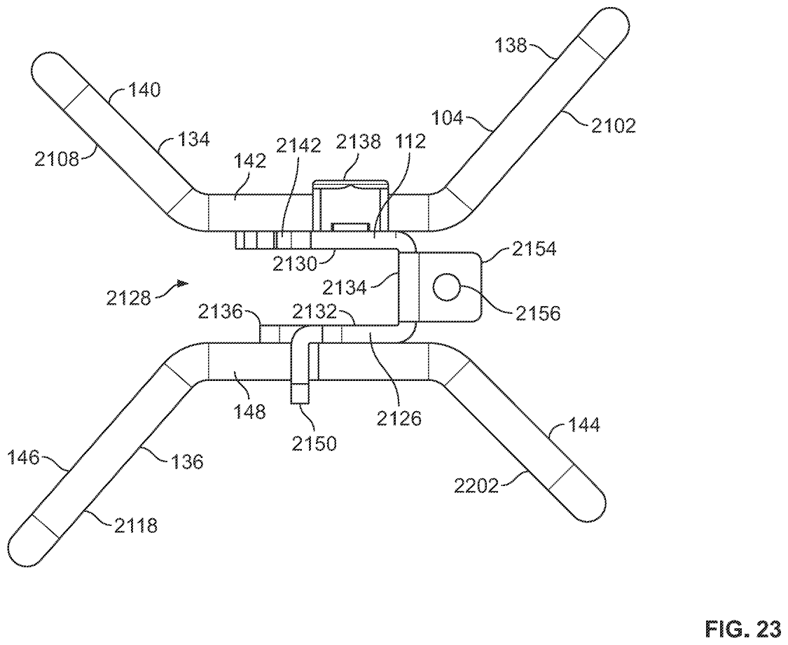

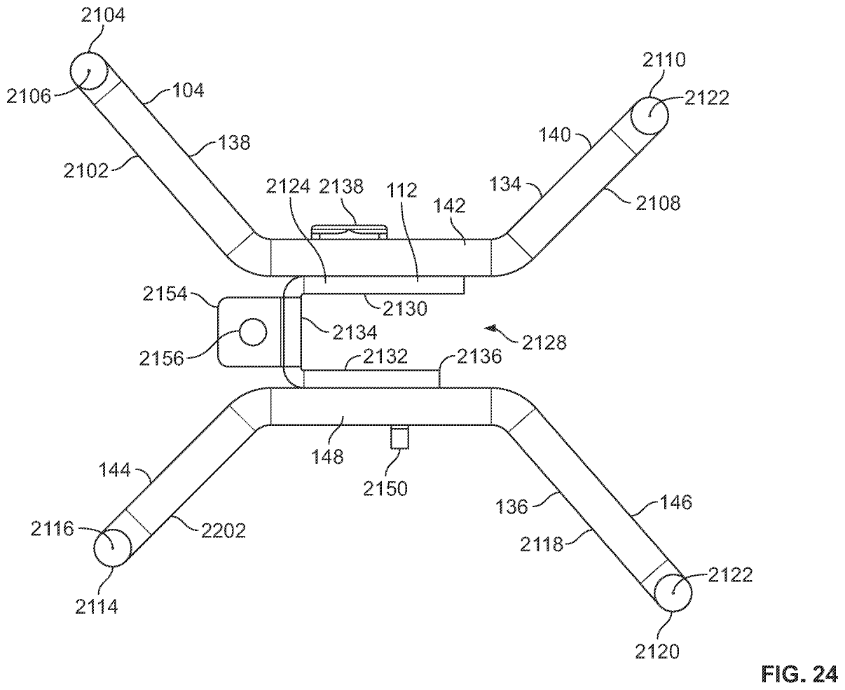

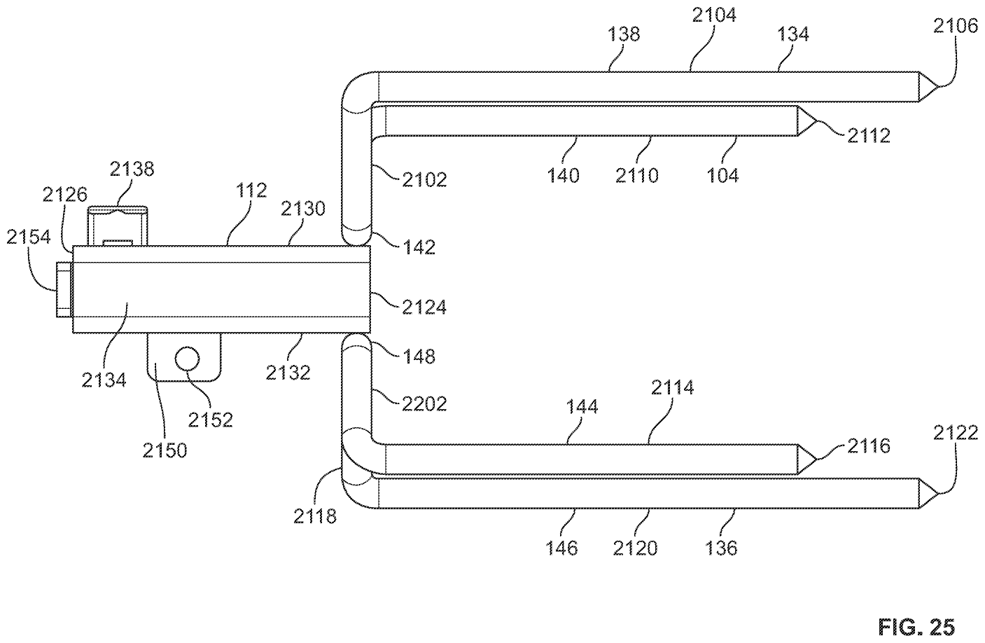

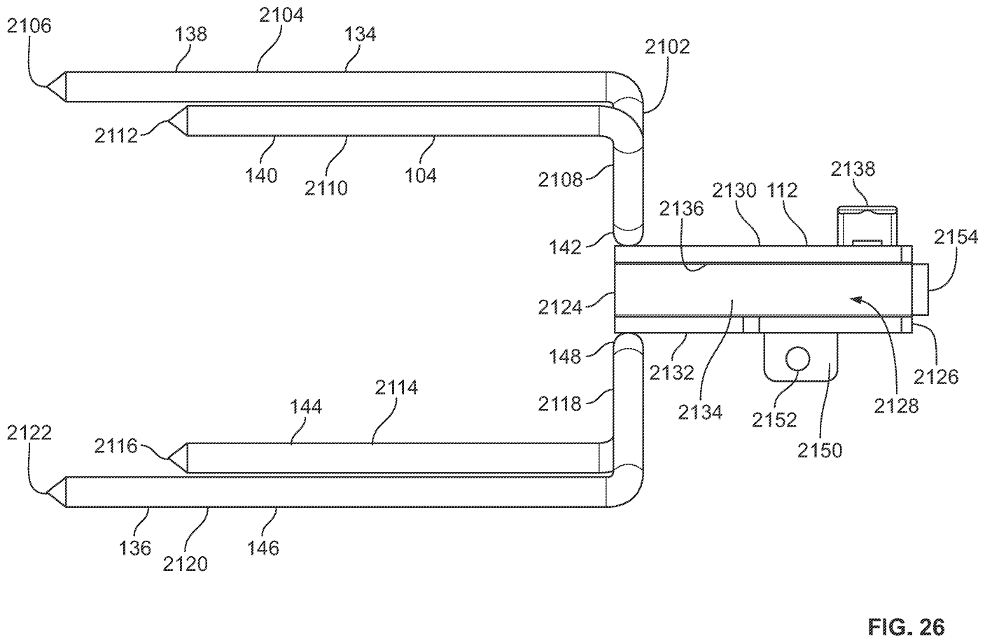

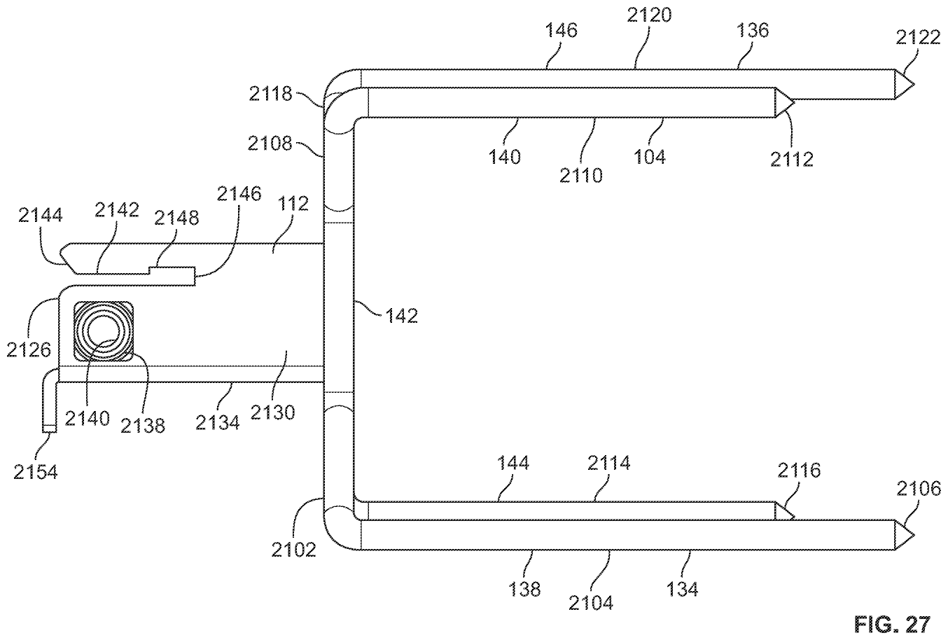

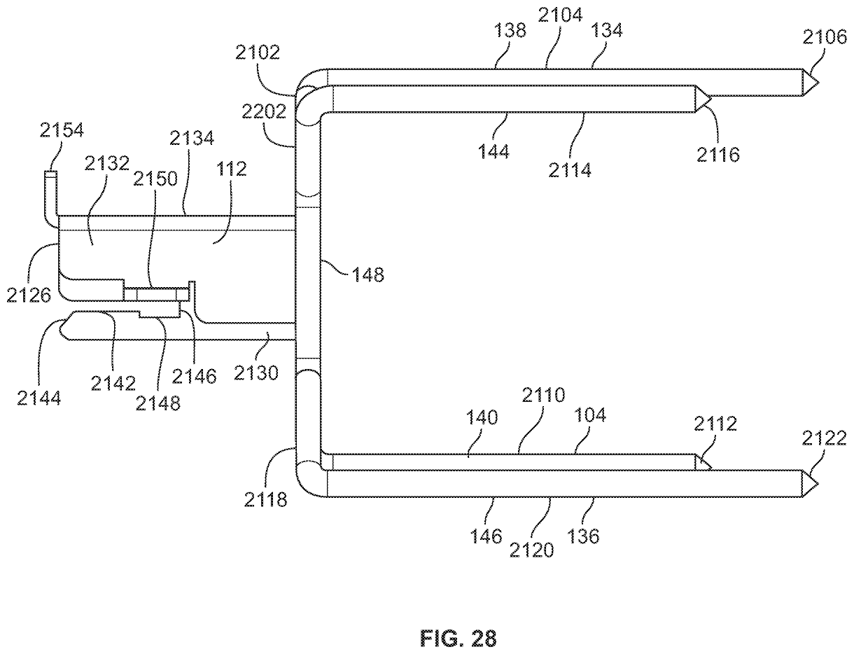

The second fork 104 of the rotisserie fork set 100 is generally structured as a mirrored image of the above-described first fork 102 of the rotisserie fork set 100. Additional views of the second fork 104 of the rotisserie fork set 100 of FIGS. 1-8 are shown in FIGS. 21-28. In this regard, FIG. 21 is a first perspective view of the second fork 104 of FIGS. 1-8. FIG. 22 is a second perspective view of the second fork 104 of FIGS. 1-8 and 21. FIG. 23 is a left side view of the second fork 104 of FIGS. 1-8, 21 and 22. FIG. 24 is a right side view of the second fork 104 of FIGS. 1-8 and 21-23. FIG. 25 is a front view of the second fork 104 of FIGS. 1-8 and 21-24. FIG. 26 is a rear view of the second fork 104 of FIGS. 1-8 and 21-25. FIG. 27 is a top view of the second fork 104 of FIGS. 1-8 and 21-26. FIG. 28 is a bottom view of the second fork 104 of FIGS. 1-8 and 21-27. In the illustrated views of FIGS. 21-28, the second fastener 114 and the second clip 116 associated with the second fork 104 have been omitted for clarity.

The second fork 104 of FIGS. 1-8 and 21-28 includes an example upper prong unit 134 and an example lower prong unit 136 spaced apart from the upper prong unit 134. In the illustrated example of FIGS. 1-8 and 21-28, the upper prong unit 134 of the second fork 104 is generally located above the second mounting bracket 112 of the second fork 104, and the lower prong unit 136 of the second fork 104 is generally located below the second mounting bracket 112 of the second fork 104.

The upper prong unit 134 of the second fork 104 of FIGS. 1-8 and 21-28 includes an example first upper prong 138, an example second upper prong 140, and an example upper base 142. The upper base 142 is located between the first upper prong 138 and the second upper prong 140, with the upper base 142 coupling the upper prong unit 134 of the second fork 104 to an upper wall of the second mounting bracket 112 of the second fork 104, as further described below. Although the upper prong unit 134 of the second fork 104 is shown in FIGS. 1-8 and 21-28 as having two prongs, the upper prong unit 134 can in other examples have a different number (e.g., 1, 3, 4, etc.) of prongs.

In the illustrated example of FIGS. 1-8 and 21-28, the first upper prong 138 of the upper prong unit 134 includes an example radial segment 2102 and an example axial segment 2104. The radial segment 2102 of the first upper prong 138 is coupled to (e.g., integrally formed with) and extends radially (e.g., forwardly and upwardly) away from the upper base 142 of the upper prong unit 134. The axial segment 2104 of the first upper prong 138 is coupled to (e.g., integrally formed with) and extends laterally (e.g., axially) away from the radial segment 2102 of the first upper prong 138. The axial segment 2104 of the first upper prong 138 includes an example free end 2106 having a spiked tip configured to pierce one or more item(s) of food to facilitate loading the item(s) of food onto the first upper prong 138 and/or, more generally, onto the second fork 104. In the illustrated example of FIGS. 1-8 and 21-28, the first upper prong 138 has an L-shaped profile. In the other examples, the first upper prong 138 can alternatively have a profile that differs from the L-shaped profile shown in FIGS. 1-8 and 21-28.

In the illustrated example of FIGS. 1-8 and 21-28, the second upper prong 140 of the upper prong unit 134 includes an example radial segment 2108 and an example axial segment 2110. The radial segment 2108 of the second upper prong 140 is coupled to (e.g., integrally formed with) and extends radially (e.g., rearwardly and upwardly) away from the upper base 142 of the upper prong unit 134. The axial segment 2110 of the second upper prong 140 is coupled to (e.g., integrally formed with) and extends laterally (e.g., axially) away from the radial segment 2108 of the second upper prong 140. The axial segment 2110 of the second upper prong 140 includes an example free end 2112 having a spiked tip configured to pierce one or more item(s) of food to facilitate loading the item(s) of food onto the second upper prong 140 and/or, more generally, onto the second fork 104. In the illustrated example of FIGS. 1-8 and 21-28, the second upper prong 140 has an L-shaped profile. In the other examples, the second upper prong 140 can alternatively have a profile that differs from the L-shaped profile shown in FIGS. 1-8 and 21-28.

The lower prong unit 136 of the second fork 104 of FIGS. 1-8 and 21-28 includes an example first lower prong 144, an example second lower prong 146, and an example lower base 148. The lower base 148 is located between the first lower prong 144 and the second lower prong 146, with the lower base 148 coupling the lower prong unit 136 of the second fork 104 to a lower wall of the second mounting bracket 112 of the second fork 104, as further described below. Although the lower prong unit 136 of the second fork 104 is shown in FIGS. 1-8 and 21-28 as having two prongs, the lower prong unit 136 can in other examples have a different number (e.g., 1, 3, 4, etc.) of prongs. Furthermore, although the upper prong unit 134 and the lower prong unit 136 of the second fork 104 are shown in FIGS. 1-8 and 21-28 as having a matching number of prongs (e.g., two each), the number of prongs of the lower prong unit 136 of the second fork 104 can in other example differ from the number of prongs of the upper prong unit 134 of the second fork 104.

In the illustrated example of FIGS. 1-8 and 21-28, the first lower prong 144 of the lower prong unit 136 includes an example radial segment 2202 and an example axial segment 2114. The radial segment 2202 of the first lower prong 144 is coupled to (e.g., integrally formed with) and extends radially (e.g., forwardly and downwardly) away from the lower base 148 of the lower prong unit 136. The axial segment 2114 of the first lower prong 144 is coupled to (e.g., integrally formed with) and extends laterally (e.g., axially) away from the radial segment 2202 of the first lower prong 144. The axial segment 2114 of the first lower prong 144 includes an example free end 2116 having a spiked tip configured to pierce one or more item(s) of food to facilitate loading the item(s) of food onto the first lower prong 144 and/or, more generally, onto the second fork 104. In the illustrated example of FIGS. 1-8 and 21-28, the first lower prong 144 has an L-shaped profile. In the other examples, the first lower prong 144 can alternatively have a profile that differs from the L-shaped profile shown in FIGS. 1-8 and 21-28.

In the illustrated example of FIGS. 1-8 and 21-28, the second lower prong 146 of the lower prong unit 136 includes an example radial segment 2118 and an example axial segment 2120. The radial segment 2118 of the second lower prong 146 is coupled to (e.g., integrally formed with) and extends radially (e.g., rearwardly and downwardly) away from the lower base 148 of the lower prong unit 136. The axial segment 2120 of the second lower prong 146 is coupled to (e.g., integrally formed with) and extends laterally (e.g., axially) away from the radial segment 2118 of the second lower prong 146. The axial segment 2120 of the second lower prong 146 includes an example free end 2122 having a spiked tip configured to pierce one or more item(s) of food to facilitate loading the item(s) of food onto the second lower prong 146 and/or, more generally, onto the second fork 104. In the illustrated example of FIGS. 1-8 and 21-28, the second lower prong 146 has an L-shaped profile. In the other examples, the second lower prong 146 can alternatively have a profile that differs from the L-shaped profile shown in FIGS. 1-8 and 21-28.

The second mounting bracket 112 of the second fork 104 of FIGS. 1-8 and 21-28 extends laterally (e.g., axially) away from the upper prong unit 134 and the lower prong unit 136 of the second fork 104. In the illustrated example of FIGS. 1-8 and 21-28, the second mounting bracket 112 is oriented and/or positioned orthogonally relative to the upper base 142 of the upper prong unit 134 and/or relative to the lower base 148 of the lower prong unit 136. In other examples, the second mounting bracket 112 can alternatively be oriented and/or positioned non-orthogonally relative to the upper base 142 of the upper prong unit 134 and/or relative to the lower base 148 of the lower prong unit 136. In the illustrated example of FIGS. 1-8 and 21-28, the second mounting bracket 112 is integrally formed with (e.g., mechanically inseparable from) the upper base 142 of the upper prong unit 134 and the lower base 148 of the lower prong unit 136. In other examples, the second mounting bracket 112 can alternatively be removably coupled to the upper base 142 of the upper prong unit 134 and/or the lower base 148 of the lower prong unit 136 via one or more fastener(s).

The second mounting bracket 112 of FIGS. 1-8 and 21-28 includes an example first end 2124 positioned adjacent (e.g., in contact with) the upper base 142 of the upper prong unit 134 and/or the lower base 148 of the lower prong unit 136, and an example second end 2126 (e.g., a free end) located opposite the first end 2124. The second mounting bracket 112 defines an example mounting channel 2128 that extends laterally (e.g., in a left-to-right direction) from the second end 2126 of the second mounting bracket 112 through to the first end 2124 of the second mounting bracket 112, thereby providing a lateral (e.g., axial) passageway through the second mounting bracket 112. As shown in FIGS. 21-28, the mounting channel 2128 of the second mounting bracket 112 includes an example upper wall 2130, an example lower wall 2132 located opposite the upper wall 2130, an example front wall 2134 extending between the upper wall 2130 and the lower wall 2132, and an example rear opening 2136 located opposite the front wall 2134 and extending between the upper wall 2130 and the lower wall 2132.

In the illustrated example of FIGS. 1-8 and 21-28, the upper wall 2130, the lower wall 2132, the front wall 2134, and the rear opening 2136 of the mounting channel 2128 respectively extend from the first end 2124 of the second mounting bracket 112 to the second end 2126 of the second mounting bracket 112. In other examples, the upper wall 2130, the lower wall 2132, and/or the front wall 2134 can alternatively extend only partially between the first end 2124 of the second mounting bracket 112 and the second end 2126 of the second mounting bracket 112. In the illustrated example of FIGS. 1-8 and 21-28, the upper wall 2130, the lower wall 2132, and the front wall 2134 of the mounting channel 2128 are respectively formed as planar (e.g., linear) walls. In other examples, one or more of the upper wall 2130, the lower wall 2132, and/or the front wall 2134 of the mounting channel 2128 can alternatively be formed as a curved (e.g., non-linear) wall. In the illustrated example of FIGS. 1-8 and 21-28, the mounting channel 2128 has a C-shaped profile. In the other examples, the mounting channel 2128 can alternatively have a profile that differs from the C-shaped profile shown in FIGS. 1-8 and 21-28.

In the illustrated example of FIGS. 1-8 and 21-28, the mounting channel 2128 of the second mounting bracket 112 is configured to be laterally (e.g., axially) aligned with the mounting channel 928 of the first mounting bracket 106. For example, the mounting channel 2128 of the second mounting bracket 112 can be laterally (e.g., axially) aligned with the mounting channel 928 of the first mounting bracket 106 in response the second mounting bracket 112 and the first mounting bracket 106 both being coupled to (e.g., transversely loaded onto) a rotisserie spit.

The upper wall 2130, the lower wall 2132, the front wall 2134, and the rear opening 2136 of the mounting channel 2128 are collectively configured to receive and/or accommodate a rotisserie spit. In this regard, the mounting channel 2128 of the second mounting bracket 112 is constructed as a rearwardly-facing and/or rearwardly-opening channel that is advantageously configured to receive a rotisserie spit via the rear opening 2136 of the mounting channel 2128. The second mounting bracket 112 can accordingly be loaded onto and/or unloaded from a rotisserie spit in a transverse direction (e.g., relative to a longitudinal axis of the rotisserie spit) via the rear opening 2136 of the mounting channel 2128, as further described below.

The second mounting bracket 112 of FIGS. 1-8 and 21-28 further includes an example nut 2138 fixedly coupled (e.g., welded) to a topside of the upper wall 2130 of the second mounting bracket 112. In the illustrated example of FIGS. 1-8 and 21-28, the nut 2138 of the second mounting bracket 112 includes an example threaded opening 2140 that is vertically aligned with (e.g., coaxially positioned relative to) an opening (e.g., a through hole) formed in and extending through the upper wall 2130 of the second mounting bracket 112. The nut 2138 is configured to threadedly receive and/or accommodate a threaded portion of a shaft of the second fastener 114 associated with the second mounting bracket 112, as further described below.

The second mounting bracket 112 of FIGS. 1-8 and 21-28 further includes an example slot 2142 formed in and extending through the upper wall 2130 of the second mounting bracket 112. In the illustrated example of FIGS. 1-8 and 21-28, the slot 2142 includes an example first end 2144 (e.g., an open end) and an example second end 2146 (e.g., a closed end) located opposite the first end 2144. The first end 2144 of the slot 2142 is configured to receive an engagement portion of the second clip 116 associated with the second mounting bracket 112, as further described below. In this regard, the second clip 116 is slidable and/or rotatable into and out of the first end 2144 of the slot 2142, and is further slidable and/or rotatable within the slot 2142 between the first end 2144 and the second end 2146 of the slot 2142. In the illustrated example of FIGS. 1-8 and 21-28, the second end 2146 of the slot 2142 includes an example expansion notch 2148 that is configured to receive the engagement portion of the second clip 116 as the second clip 116 slides and/or rotates from the first end 2144 to the second end 2146 of the slot 2142. The expansion notch 2148 is further configured to function as a mechanical stop that restricts the engagement portion of the second clip 116 from inadvertently sliding and/or rotating from the second end 2146 of the slot 2142 back to the first end 2144 of the slot 2142 absent physical manipulation of the second clip 116 by a user. In other examples, the expansion notch 2148 can instead be omitted from the slot 2142.

The second mounting bracket 112 of FIGS. 1-8 and 21-28 further includes an example clip flange 2150 that extends downwardly from the lower wall 2132 of the second mounting bracket 112. In the illustrated example of FIGS. 1-8 and 21-28, the clip flange 2150 is integrally formed with (e.g., mechanically inseparable from) the second mounting bracket 112. In other examples, the clip flange 2150 can alternatively be removably coupled to the second mounting bracket 112 via one or more fastener(s). The clip flange 2150 includes an example opening 2152 that facilitates the attachment of the second clip 116 to the second mounting bracket 112 and/or, more generally, to the second fork 104, as further described below.

The second mounting bracket 112 of FIGS. 1-8 and 21-28 further includes an example cable flange 2154 that extends forwardly from the front wall 2134 of the second mounting bracket 112. In the illustrated example of FIGS. 1-8 and 21-28, the cable flange 2154 is integrally formed with (e.g., mechanically inseparable from) the second mounting bracket 112. In other examples, the cable flange 2154 can alternatively be removably coupled to the second mounting bracket 112 via one or more fastener(s). The cable flange 2154 includes an example opening 2156 that facilitates the attachment of a first end of a metal cable to the cable flange 2154. A second end of the metal cable located opposite the first end of the metal cable can be attached to a portion (e.g., a shaft or a looped portion) of the second fastener 114, as shown in FIGS. 1-8. Attachment of the second fastener 114 to the cable flange 2154 via the metal cable advantageously tethers the second fastener 114 to the second mounting bracket 112 so as to prevent the second fastener 114 from becoming completely separated from the second mounting bracket 112 and/or, more generally, from the second fork 104 when the second fastener 114 is not threadedly coupled to the nut 2138 of the second mounting bracket 112.

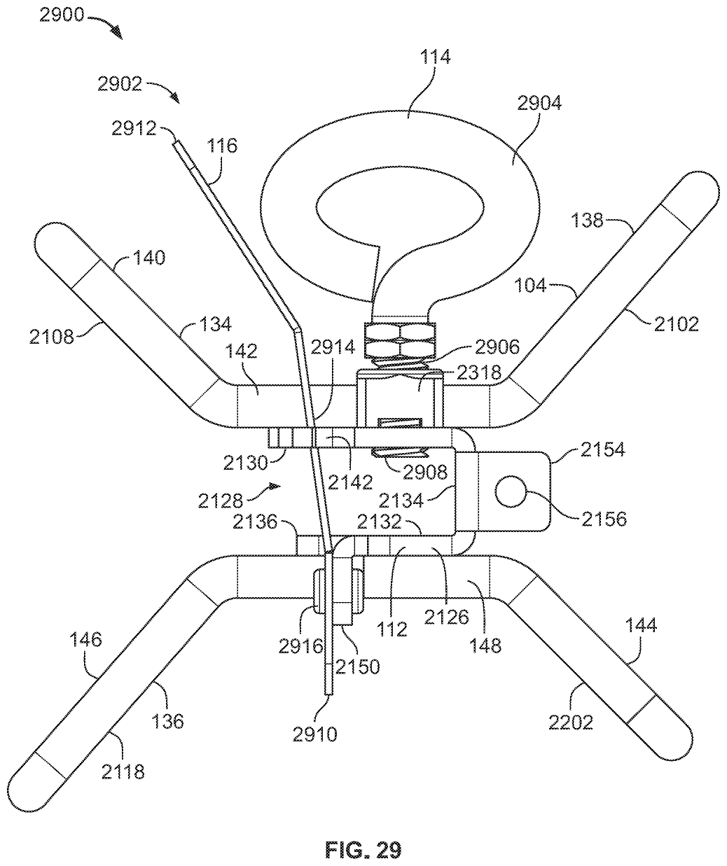

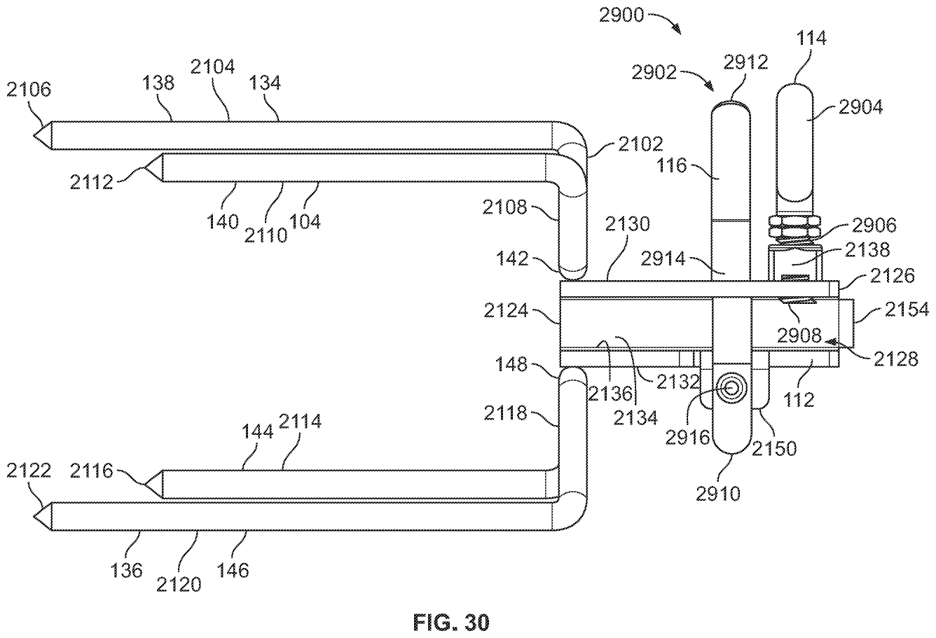

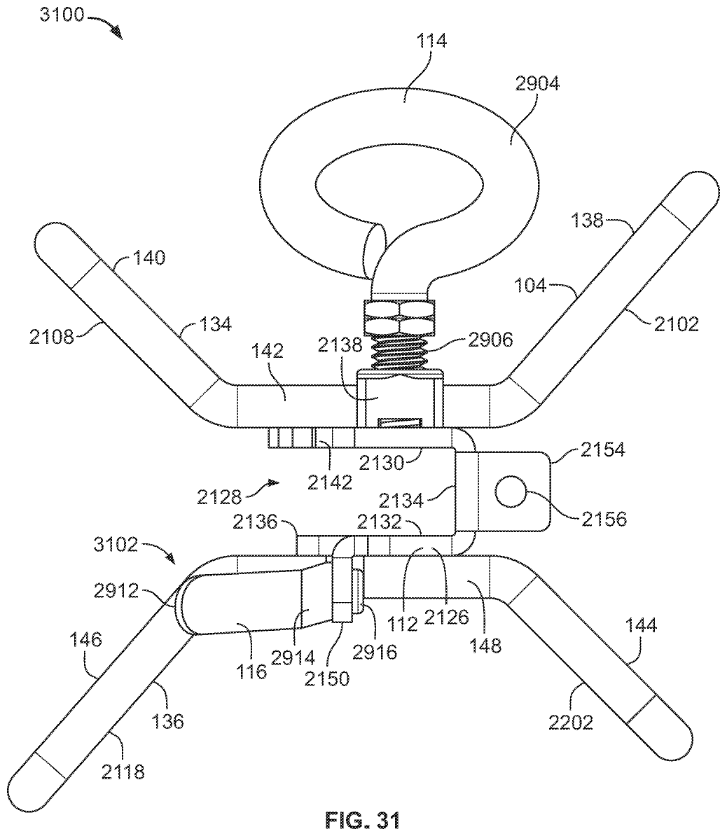

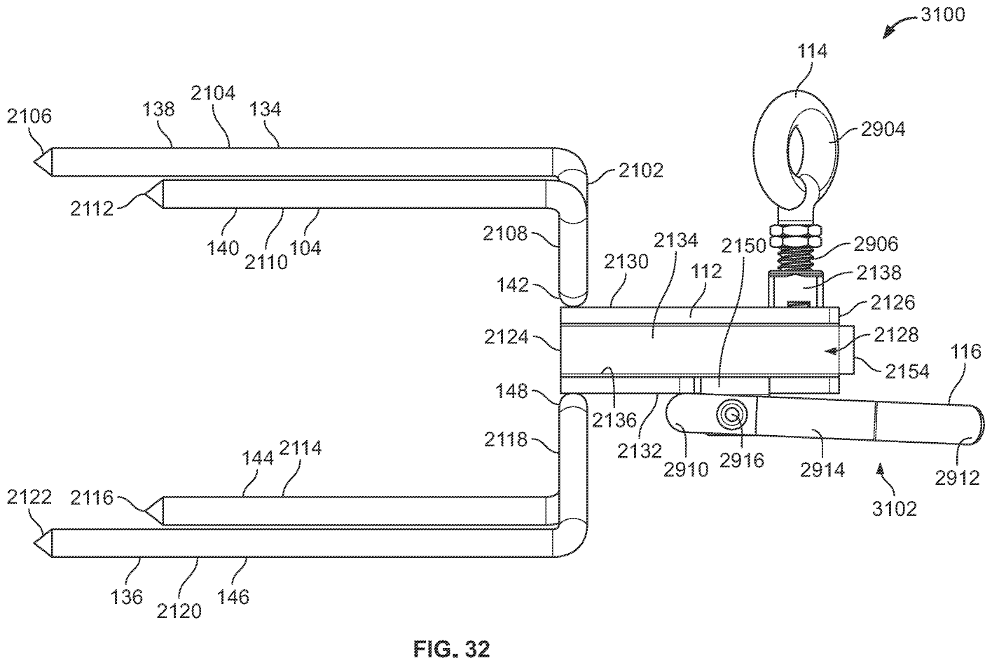

FIG. 29 is a left side view of the second fork 104 of FIGS. 1-8 and 21-28, with the second fastener 114 of FIGS. 1-8 shown in an example locked position 2900, and with the second clip 116 of FIGS. 1-8 shown in an example closed position 2902. FIG. 30 is a rear view of the second fork 104 of FIGS. 1-8 and 21-29, with the second fastener 114 of FIGS. 1-8 and 29 shown in the locked position 2900 of FIG. 29, and with the second clip 116 of FIGS. 1-8 and 29 shown in the closed position 2902 of FIG. 29. FIG. 31 is a left side view of the second fork 104 of FIGS. 1-8 and 21-30, with the second fastener 114 of FIGS. 1-8, 29, and 30 shown in an example unlocked position 3100, and with the second clip 116 of FIGS. 1-8, 29, and 30 shown in an example open position 3102. FIG. 32 is a rear view of the second fork 104 of FIGS. 1-8 and 21-31, with the second fastener 114 of FIGS. 1-8 and 29-31 shown in the unlocked position 3100 of FIG. 31, and with the second clip 116 of FIGS. 1-8 and 29-31 shown in the open position 3102 of FIG. 31.

In the illustrated example of FIGS. 1-8 and 29-32, the second fastener 114 is constructed as an eyebolt having an example looped portion 2904 and an example shaft 2906 extending from the looped portion 2904. The shaft 2906 of the second fastener 114 includes an example free end 2908 located opposite the looped portion 2904 of the second fastener 114. In the illustrated example of FIGS. 1-8 and 29-32, the shaft 2906 of the second fastener 114 is threaded along a substantial entirety of its length. In other examples, the shaft 2906 of the second fastener 114 can alternatively be threaded along only a portion of the length of the shaft 2906. Although the second fastener 114 of the second fork 104 of FIGS. 1-8 and 29-32 is constructed as an eyebolt, the second fastener 114 can alternatively be constructed as any type of known fastener having a threaded shaft (e.g., a bolt, a screw, etc.).

The shaft 2906 of the second fastener 114 of FIGS. 1-8 and 29-32 is configured to be threadedly received in the threaded opening 2140 of the nut 2138 of the second mounting bracket 112 such that the shaft 2906 and/or, more generally, the second fastener 114 is movable between the locked position 2900 shown in FIGS. 29 and 30 and the unlocked position 3100 shown in FIGS. 31 and 32. In this regard, the second fastener 114 can be threadedly coupled to the threaded opening 2140 of the nut 2138 of the second mounting bracket 112 by placing the free end 2908 of the shaft 2906 into the threaded opening 2140 of the nut 2138, and then rotating the second fastener 114 (e.g., in a clockwise direction) so as to engage the threaded portion of the shaft 2906 with the threaded opening 2140 of the nut 2138. As shown in FIGS. 29 and 30, the free end 2908 of the shaft 2906 of the second fastener 114 partially blocks, obstructs, and/or otherwise interferes with an upper aspect of a forward portion of the mounting channel 2128 of the second mounting bracket 112 when the second fastener 114 is positioned in the locked position 2900. Conversely, as shown in FIGS. 31 and 32, the free end 2908 of the shaft 2906 of the second fastener 114 does not block, obstruct, and/or otherwise interfere with any aspect of the forward portion of the mounting channel 2128 of the second mounting bracket 112 when the second fastener 114 is positioned in the unlocked position 3100.

In the illustrated example of FIGS. 29-32, the second fastener 114 is movable from the locked position 2900 to the unlocked position 3100 by rotating the second fastener 114 in a counter-clockwise direction, and is conversely movable from the unlocked position 3100 to the locked position 2900 by rotating the second fastener 114 in a clockwise direction. In other examples, the second fastener 114 can instead be movable from the locked position 2900 to the unlocked position 3100 by rotating the second fastener 114 in a clockwise direction, and can conversely be movable from the unlocked position 3100 to the locked position 2900 by rotating the second fastener 114 in a counter-clockwise direction.

As described in greater detail below, the second fastener 114 is to be removed from the locked position 2900 of FIGS. 29 and 30 prior to the second mounting bracket 112 being transversely loaded onto a rotisserie spit. In this regard, the second fastener 114 will typically be unthreaded from the locked position 2900 of FIGS. 29 and 30 to the unlocked position 3100 of FIGS. 31 and 32 such that the free end 2908 of the shaft 2906 of the second fastener 114 is not blocking any aspect of the forward portion of the mounting channel 2128 of the second mounting bracket 112 in preparation of the second mounting bracket 112 being transversely loaded onto the rotisserie spit. Subsequent to the second mounting bracket 112 being transversely loaded onto the rotisserie spit via the rear opening 2136 of the mounting channel 2128 of the second mounting bracket 112, the second fastener 114 can thereafter be moved from the unlocked position 3100 of FIGS. 31 and 32 to the locked position 2900 of FIGS. 29 and 30 to securely couple the second mounting bracket 112 and/or, more generally, the second fork 104 to the rotisserie spit.

When the second fastener 114 is placed in the locked position 2900, the free end 2908 of the shaft 2906 of the second fastener 114 extends into the mounting channel 2128 of the second mounting bracket 112 so as to engage a rotisserie spit located therein. The engagement between the free end 2908 of the shaft 2906 of the second fastener 114 and the rotisserie spit forces the rotisserie spit into pressurized and/or forceable contact with the lower wall 2132 of the mounting channel 2128, thereby securely coupling the second mounting bracket 112 and/or, more generally, the second fork 104 to the rotisserie spit. The second mounting bracket 112 and/or, more generally, the second fork 104 can conversely be transversely unloaded from the rotisserie spit in response to the second fastener 114 being unthreaded from the locked position 2900 of FIGS. 29 and 30 to the unlocked position 3100 of FIGS. 31 and 32 such that the free end 2908 of the shaft 2906 of the second fastener 114 is no longer contacting the rotisserie spit, and/or such that the free end 2908 of the shaft 2906 of the second fastener 114 is no longer blocking any aspect of the forward portion of the mounting channel 2128 of the second mounting bracket 112 that would interfere with the rotisserie spit being removed therefrom.

In the illustrated example of FIGS. 1-8 and 29-32, the second clip 116 is constructed as a thin, semi-flexible rod having an example first end 2910, an example second end 2912 located opposite the first end 2910, and an example engagement portion 2914 located between the first end 2910 and the second end 2912. A portion of the second clip 116 located proximate the first end 2910 is configured to be pivotably coupled to the clip flange 2150 of the second mounting bracket 112 of the second fork 104 such that the second clip 116 is rotatable relative to the second mounting bracket 112, and such that the engagement portion 2914 of the second clip 116 is receivable and/or movable within the slot 2142 of the second mounting bracket 112. For example, as shown in FIGS. 29-32, the second clip 116 is pivotably coupled to the clip flange 2150 of the second mounting bracket 112 of the second fork 104 via an example rivet 2916 located proximate the first end 2910 of the second clip 116, with the rivet 2916 extending through an opening formed in the second clip 116 and further extending through the opening 2152 formed in the clip flange 2150.

In the illustrated example of FIGS. 29-32, the engagement portion 2914 of the second clip 116 is movable between the closed position 2902 shown in FIGS. 29 and 30 and the open position 3102 shown in FIGS. 31 and 32. In this regard, the second clip 116 can be moved between the closed position 2902 and the open position 3102 by physically manipulating the second end 2912 of the second clip 116 so as to cause the engagement portion 2914 of the second clip 116 to rotate and/or pivot relative to the slot 2142 of the second mounting bracket 112. As shown in FIGS. 29 and 30, the engagement portion 2914 of the second clip 116 blocks, obstructs, and/or otherwise interferes with a rearward portion of the mounting channel 2128 of the second mounting bracket 112 when the second clip 116 is positioned in the closed position 2902. Conversely, as shown in FIGS. 31 and 32, the engagement portion 2914 of the second clip 116 does not block, obstruct, and/or otherwise interfere with any aspect of the rearward portion of the mounting channel 2128 of the second mounting bracket 112 when the second clip 116 is positioned in the open position 3102.

As described in greater detail below, the second clip 116 is to be removed from the closed position 2902 of FIGS. 29 and 30 prior to the second mounting bracket 112 being transversely loaded onto a rotisserie spit. In this regard, the second clip 116 will typically be rotated from the closed position 2902 of FIGS. 29 and 30 to the open position 3102 of FIGS. 31 and 32 such that the engagement portion 2914 of the second clip 116 is not blocking any aspect of the rearward portion of the mounting channel 2128 of the second mounting bracket 112 in preparation of the second mounting bracket 112 being transversely loaded onto the rotisserie spit. Subsequent to the second mounting bracket 112 being transversely loaded onto the rotisserie spit via the rear opening 2136 of the mounting channel 2128 of the second mounting bracket 112, the second clip 116 can thereafter be moved from the open position 3102 of FIGS. 31 and 32 to the closed position 2902 of FIGS. 29 and 30 to further couple the second mounting bracket 112 and/or, more generally, the second fork 104 to the rotisserie spit.

When the second clip 116 is placed in the closed position 2902, the engagement portion 2914 of the second clip 116 extends through and/or across a rearward portion of the mounting channel 2128 (e.g., between the upper wall 2130 and the lower wall 2132) so as to transversely capture a rotisserie spit located within a forward portion of the mounting channel 2128. The second clip 116 accordingly functions as a safety clip that prevents the second mounting bracket 112 and/or, more generally, the second fork 104 from inadvertently being transversely removed from the rotisserie spit. In this regard, the engagement portion 2914 of the second clip 116 is biased (e.g., rearwardly biased) into the expansion notch 2148 of the slot 2142 of the second mounting bracket 112 when the second clip 116 is placed in the closed position 2902, with the expansion notch 2148 thereafter functioning as a mechanical stop that restricts the engagement portion 2914 of the second clip 116 from inadvertently sliding and/or rotating from the second end 2146 of the slot 2142 (e.g., out of the expansion notch 2148) back to the first end 2144 of the slot 2142 absent physical manipulation of the second clip 116 by a user. Thus, the second mounting bracket 112 and/or, more generally, the second fork 104 can only be transversely unloaded from the rotisserie spit in response to the second clip 116 being slid and/or rotated from the closed position 2902 of FIGS. 29 and 30 to the open position 3102 of FIGS. 31 and 32, such that the engagement portion 2914 of the second clip 116 is moved out of the expansion notch 2148 of the slot 2142, and such that the engagement portion 2914 of the second clip 116 is no longer blocking any aspect of the rearward portion of the mounting channel 2128 of the second mounting bracket 112 that would interfere with the rotisserie spit being removed therefrom.

As described above, the second clip 116 serves as a mechanical failsafe against inadvertent transverse removal of the second mounting bracket 112 and/or, more generally, the second fork 104 from the rotisserie spit. In this regard, it is the second fastener 114, rather than the second clip 116, that securely couples the second mounting bracket 112 and/or, more generally, the second fork 104 to the rotisserie spit. Thus, in other examples, the second clip 116 (as well as the associated slot 2142 and the associated clip flange 2150) can be omitted from the second mounting bracket 112 and/or, more generally, the second fork 104 without negatively impacting the capability of securely coupling the second mounting bracket 112 and/or, more generally, the second fork 104 to the rotisserie spit.

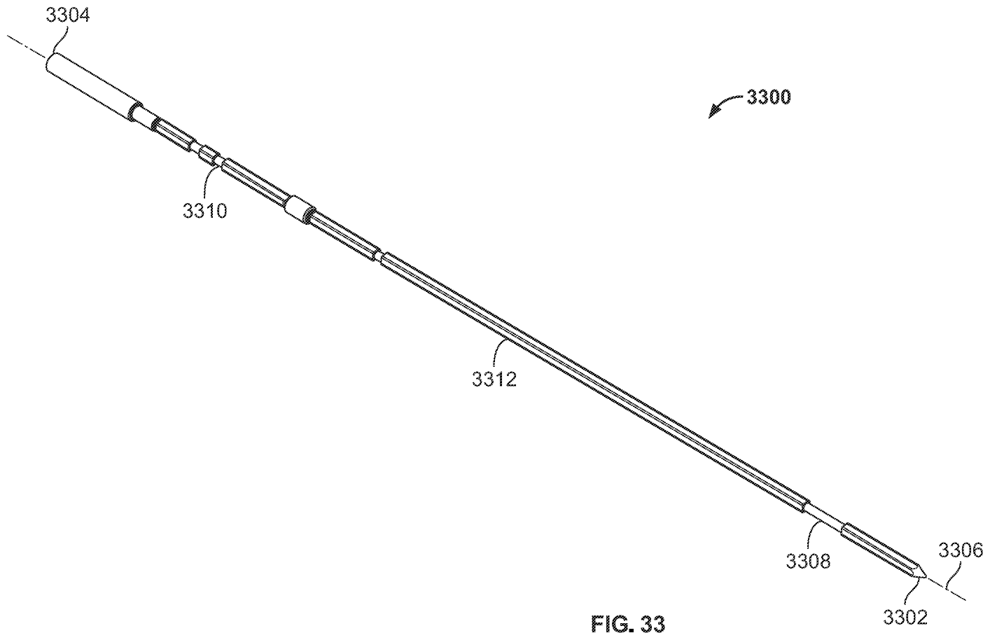

FIG. 33 is a perspective view of an example rotisserie spit 3300. The rotisserie spit 3300 of FIG. 33 includes an example first end 3302, an example second end 3304 located opposite the first end 3302, and an example longitudinal axis 3306 extending between the first end 3302 and the second end 3304. The first end 3302 of the rotisserie spit 3300 is configured to be operatively coupled to a motor of a rotisserie cooking system, whereby the motor is configured to rotate the rotisserie spit 3300 about its longitudinal axis 3306 to facilitate rotisserie-style cooking.

The rotisserie spit 3300 of FIG. 33 is configured to extend across the width of a cookbox of a grill. In this regard, the rotisserie spit 3300 includes an example first axial segment 3308 located toward the first end 3302 of the rotisserie spit 3300, an example second axial segment 3310 located toward the second end 3304 of the rotisserie spit 3300, and an example third axial segment 3312 located between the first axial segment 3308 and the second axial segment 3310 of the rotisserie spit 3300. The first axial segment 3308 is configured to be positioned within and/or supported by a notched portion of a right sidewall of the cookbox of the grill. The second axial segment 3310 is configured to be positioned within and/or supported by a notched portion of a left sidewall of the cookbox of the grill. The third axial segment 3312 is configured to be positioned between the right sidewall and the left sidewall of the cookbox of the grill.

The first axial segment 3308 and the second axial segment 3310 of the rotisserie spit 3300 respectively have a circular cross-sectional profile that facilitates rotation of the rotisserie spit 3300 on and/or within the cookbox of the grill. The third axial segment 3312 of the rotisserie spit 3300 has a rectangular cross-sectional profile that facilitates (1) transversely loading the first mounting bracket 106 and the second mounting bracket 112, and/or, more generally, the first fork 102 and the second fork 104 onto the third axial segment 3312 of the rotisserie spit 3300, and (2) securely coupling the first mounting bracket 106 and the second mounting bracket 112, and/or, more generally, the first fork 102 and the second fork 104 to the third axial segment 3312 of the rotisserie spit 3300 such that the first mounting bracket 106 and the second mounting bracket 112, and/or, more generally, the first fork 102 and the second fork 104 rotate along with the rotation (e.g., the motor-driven rotation) of the rotisserie spit 3300.

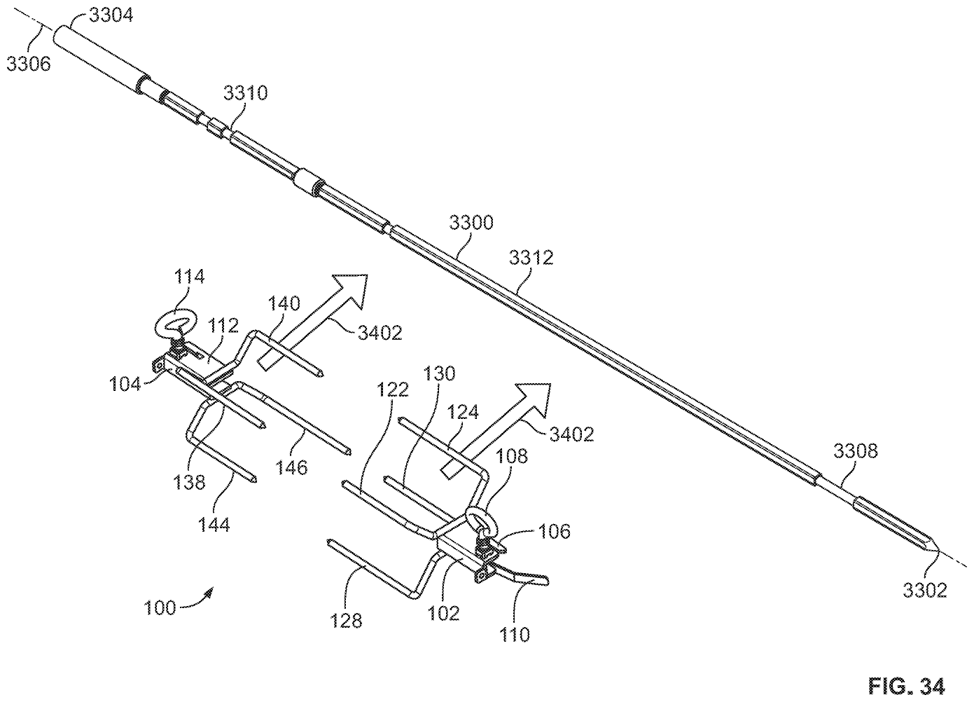

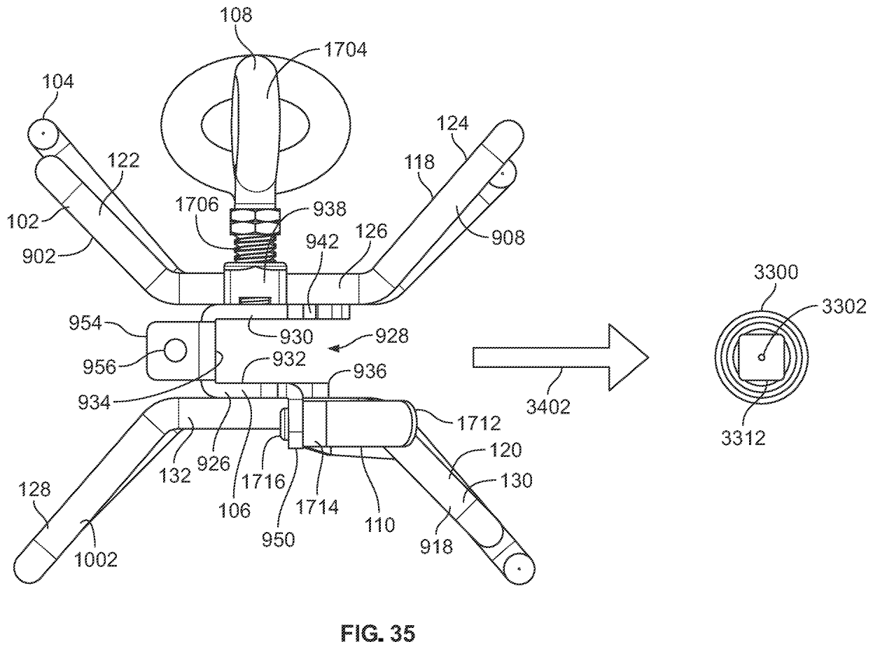

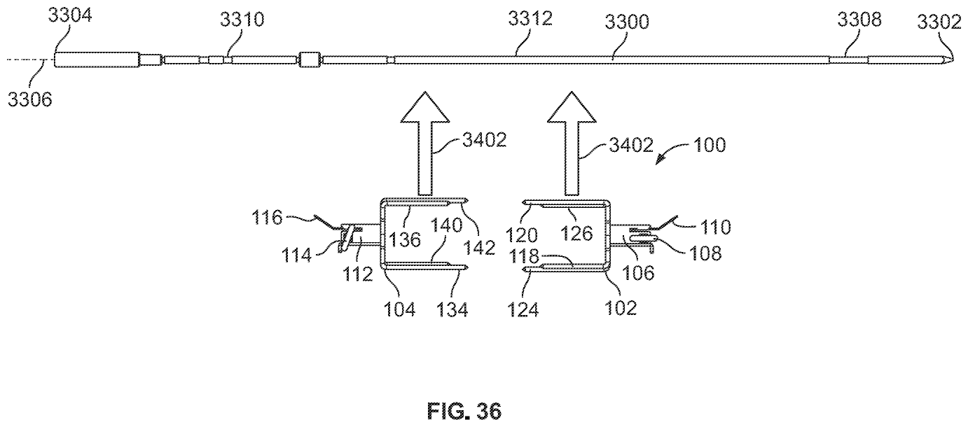

FIG. 34 is a perspective view of the rotisserie fork set 100 of FIGS. 1-8 positioned for transverse loading onto the rotisserie spit 3300 of FIG. 33. FIG. 35 is a right side view of the rotisserie fork set 100 of FIGS. 1-8 and 34 positioned for transverse loading onto the rotisserie spit 3300 of FIGS. 33 and 34. FIG. 36 is a top view of the rotisserie fork set 100 of FIGS. 1-8, 34 and 35 positioned for transverse loading onto the rotisserie spit 3300 of FIGS. 33-35.

In the illustrated example of FIGS. 34-36, the rotisserie fork set 100 is located forward of the rotisserie spit 3300, with the rear opening 936 of the mounting channel 928 of the first mounting bracket 106 of the first fork 102 and the rear opening 2136 of the mounting channel 2128 of the second mounting bracket 112 of the second fork 104 being respectively oriented toward the rotisserie spit 3300. As shown in FIGS. 34-36, the mounting channel 928 of the first mounting bracket 106 of the first fork 102 and the mounting channel 2128 of the second mounting bracket 112 of the second fork 104 are laterally (e.g., axially) aligned with one another to advantageously enable concurrent transverse loading of the first fork 102 and the second fork 104 of the rotisserie fork set 100 onto the rotisserie spit 3300. In other examples, the respective transverse loading of the first fork 102 and the second fork 104 of the rotisserie fork set 100 onto the rotisserie spit 3300 can instead be performed in a non-concurrent manner. For example, the first mounting bracket 106 of the first fork 102 of the rotisserie fork set 100 can be transversely loaded onto the rotisserie spit 3300 at a first time, and the second mounting bracket 112 of the second fork 104 of the rotisserie fork set 100 can be transversely loaded onto the rotisserie spit 3300 at a second time subsequent to the first time.

As further shown in FIGS. 34-36, the first fastener 108 of the first fork 102 is positioned in an unlocked position (e.g., the unlocked position 1900 of FIGS. 19 and 20) and the first clip 110 of the first fork 102 is positioned in an open position (e.g., the open position 1902 of FIGS. 19 and 20) such that the first fastener 108 and the first clip 110 are not blocking any portion of the mounting channel 928 of the first mounting bracket 106 of the first fork 102 in preparation of the first mounting bracket 106 being transversely loaded onto the rotisserie spit 3300. With the first fastener 108 and the first clip 110 of the first fork 102 being positioned in the aforementioned manner, the first mounting bracket 106 and/or, more generally, the first fork 102 can be transversely loaded onto the rotisserie spit 3300 by moving the first mounting bracket 106 and/or, more generally, the first fork 102 away from the position shown in FIGS. 34-36 in and/or along an example transverse direction 3402 (e.g., a rearward direction) that is generally orthogonal relative to the longitudinal axis 3306 of the rotisserie spit 3300. Similarly, the second fastener 114 of the second fork 104 is positioned in an unlocked position (e.g., the unlocked position 3100 of FIGS. 31 and 32) and the second clip 116 of the second fork 104 is positioned in an open position (e.g., the open position 3102 of FIGS. 31 and 32) such that the second fastener 114 and the second clip 116 are not blocking any portion of the mounting channel 2128 of the second mounting bracket 112 of the second fork 104 in preparation of the second mounting bracket 112 being transversely loaded onto the rotisserie spit 3300. With the second fastener 114 and the second clip 116 of the second fork 104 being positioned in the unlocked position and/or the non-blocking manner described above, the second mounting bracket 112 and/or, more generally, the second fork 104 can be transversely loaded onto the rotisserie spit 3300 by moving the second mounting bracket 112 and/or, more generally, the second fork 104 away from the position shown in FIGS. 34-36 in and/or along the transverse direction 3402 (e.g., a rearward direction) that is generally orthogonal relative to the longitudinal axis 3306 of the rotisserie spit 3300.

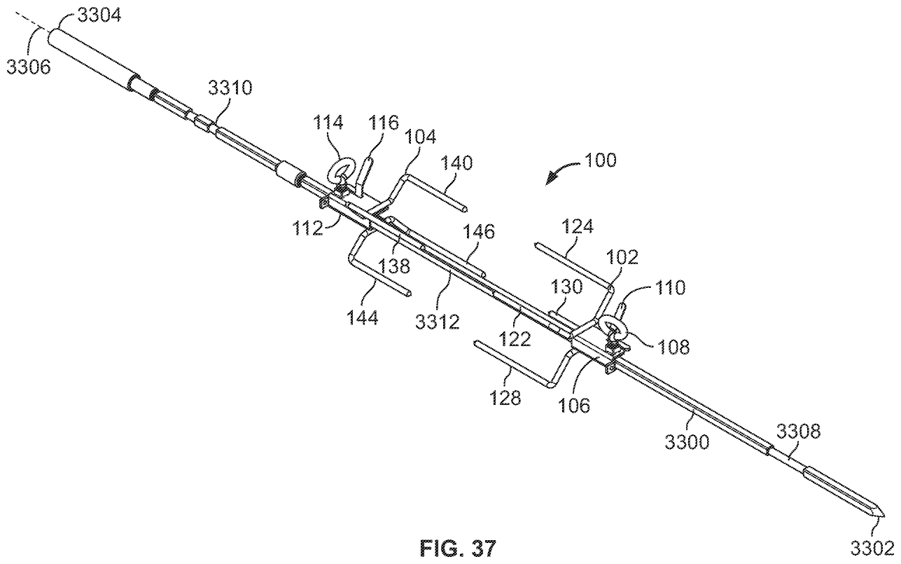

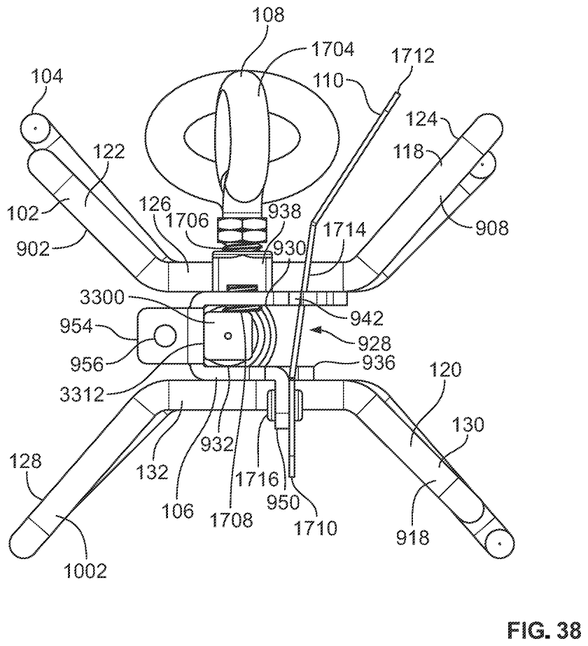

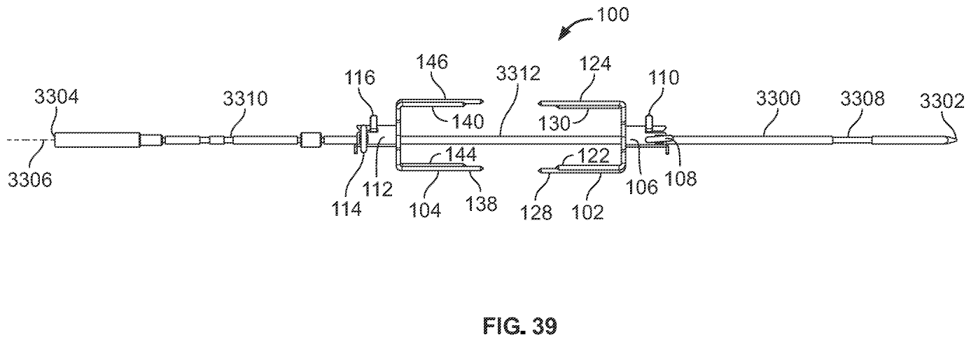

FIG. 37 is a perspective view of the rotisserie fork set 100 of FIGS. 1-8 and 34-36 transversely loaded onto the rotisserie spit 3300 of FIGS. 33-36. FIG. 38 is a right side view of the rotisserie fork set 100 of FIGS. 1-8 and 34-37 transversely loaded onto the rotisserie spit 3300 of FIGS. 33-37. FIG. 39 is a top view of the rotisserie fork set 100 of FIGS. 1-8 and 34-38 transversely loaded onto the rotisserie spit 3300 of FIGS. 33-38. In the illustrated example of FIGS. 37-39, the first mounting bracket 106 and/or, more generally, the first fork 102 has been transversely loaded onto the rotisserie spit 3300 by moving the first mounting bracket 106 and/or, more generally, the first fork 102 away from the position shown in FIGS. 34-36 and onto the rotisserie spit 3300 in and/or along the transverse direction 3402 shown in FIGS. 34-36. Transversely loading the first mounting bracket 106 and/or, more generally, the first fork 102 onto the rotisserie spit 3300 as shown in FIGS. 37-39 results in the rotisserie spit 3300 (e.g., the third axial segment 3312 of the rotisserie spit 3300) being located within and extending laterally (e.g., axially) through the mounting channel 928 of the first mounting bracket 106 of the first fork 102.

As further shown in FIGS. 37-39, the second mounting bracket 112 and/or, more generally, the second fork 104 has been transversely loaded onto the rotisserie spit 3300 by moving (e.g., either concurrently or non-concurrently with the first mounting bracket 106 and/or, more generally, the first fork 102) the second mounting bracket 112 and/or, more generally, the second fork 104 away from the position shown in FIGS. 34-36 and onto the rotisserie spit 3300 in and/or along the transverse direction 3402 shown in FIGS. 34-36. Transversely loading the second mounting bracket 112 and/or, more generally, the second fork 104 onto the rotisserie spit 3300 as shown in FIGS. 37-39 results in the rotisserie spit 3300 (e.g., the third axial segment 3312 of the rotisserie spit 3300) being located within and extending laterally (e.g., axially) through the mounting channel 2128 of the second mounting bracket 112 of the second fork 104.

In the illustrated example of FIGS. 37-39, the first fastener 108 has been moved from the unlocked position 1900 (e.g., as shown in FIGS. 19, 20, and 34-36) into the locked position 1700 (e.g., as shown in FIGS. 17 and 18), the first clip 110 has been moved from the open position 1902 (e.g., as shown in FIGS. 19, 20, and 34-36) into the closed position 1702 (e.g., as shown in FIGS. 17 and 18), the second fastener 114 has been moved from unlocked position 3100 (e.g., as shown in FIGS. 31, 32, and 34-36) into the locked position 2900 (e.g., as shown in FIGS. 29 and 30), and the second clip 116 has been moved from open position 3102 (e.g., as shown in FIGS. 31, 32, and 34-36) into the closed position 2902 (e.g., as shown in FIGS. 29 and 30). Positioning the first fastener 108 in the locked position 1700 securely couples the first mounting bracket 106 and/or, more generally, the first fork 102 to the rotisserie spit 3300 (e.g., to the third axial segment 3312 of the rotisserie spit 3300) such that the first mounting bracket 106 and/or, more generally, the first fork 102 rotate(s) along with the rotation (e.g., the motor-driven rotation) of the rotisserie spit 3300. Positioning the first clip 110 in the closed position 1702 provides a mechanical failsafe that prevents the first mounting bracket 106 and/or, more generally, the first fork 102 from inadvertently being transversely removed from the rotisserie spit 3300. Positioning the second fastener 114 in the locked position 2900 securely couples the second mounting bracket 112 and/or, more generally, the second fork 104 to the rotisserie spit 3300 (e.g., to the third axial segment 3312 of the rotisserie spit 3300) such that the second mounting bracket 112 and/or, more generally, the second fork 104 rotate(s) along with the rotation (e.g., the motor-driven rotation) of the rotisserie spit 3300. Positioning the second clip 116 in the closed position 2902 provides a mechanical failsafe that prevents the second mounting bracket 112 and/or, more generally, the second fork 104 from inadvertently being transversely removed from the rotisserie spit 3300.

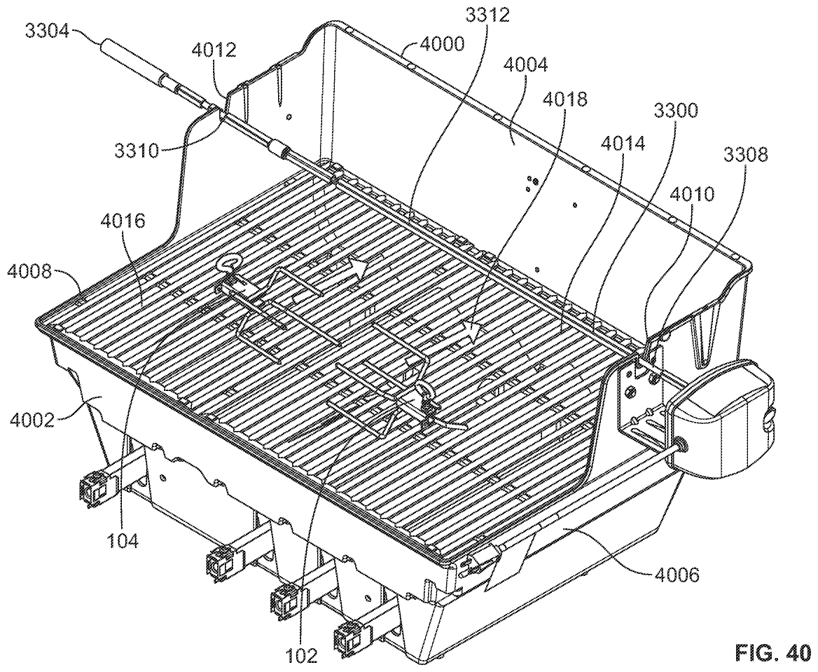

FIG. 40 is a perspective view of an example cookbox 4000 of a grill, showing the rotisserie fork set 100 of FIGS. 1-8 and 34-39 positioned for transverse loading onto the rotisserie spit 3300 of FIGS. 33-39. The cookbox 4000 of FIG. 40 includes an example front wall 4002, an example rear wall 4004 located opposite the front wall 4002, an example right sidewall 4006 extending between the front wall 4002 and the rear wall 4004, and an example left sidewall 4008 located opposite the right sidewall 4006 and extending between the front wall 4002 and the rear wall 4004. The right sidewall 4006 of the cookbox 4000 includes an example first notched portion 4010 configured to support the first axial segment 3308 of the rotisserie spit 3300. The left sidewall 4008 of the cookbox 4000 includes an example second notched portion 4012 that is laterally (e.g., axially) aligned with the first notched portion 4010 of the right sidewall 4006 of the cookbox 4000 and configured to support the second axial segment 3310 of the rotisserie spit 3300. The rotisserie spit 3300 is accordingly configured to extend laterally (e.g., axially) from the right sidewall 4006 of the cookbox 4000 to the left sidewall 4008 of the cookbox 4000, with the third axial segment 3312 of the rotisserie spit 3300 being located between the right sidewall 4006 of the cookbox 4000 and the left sidewall 4008 of the cookbox 4000.

In the illustrated example of FIG. 40, the cookbox 4000 carries, supports, contains, houses, and/or otherwise includes one or more burner tube(s) configured to generate and/or emit heat-producing gas flames. As shown in FIG. 40, the cookbox 4000 is configured to include four burner tubes. In other examples, the cookbox 4000 can instead include a different number (e.g., 2, 3, 5, etc.) of burner tubes. Furthermore, although FIG. 40 illustrates burner tubes of a cookbox of a gas grill, in other examples the cookbox 4000 can instead be configured to include a burn pot of a pellet grill, an electric heating element of an electric grill, a charcoal rack or bin of a charcoal grill, etc. It should accordingly be understood that the cookbox 4000 shown in FIG. 40 represents one particular cookbox configuration and/or grill type from among many cookbox configurations and/or grill types with which the rotisserie fork set 100 disclosed herein can be used.

The cookbox 4000 of FIG. 40 also carries, supports, contains, houses, and/or otherwise includes one or more grease deflection bar(s) configured to have an inverted V-shaped profile. As one or more food item(s) is/are cooked within the cookbox 4000, grease produced by the cooking food item(s) falls downward onto the grease deflection bar(s). The inverted V-shaped profile of each grease deflection bar directs such grease to a further downward location within the cookbox 4000, while in some instances also shielding an underlying one of the aforementioned burner tubes of the cookbox 4000 from being exposed to such grease. The cookbox 4000 of FIG. 40 also carries, supports, contains, houses, and/or otherwise includes one or more cooking grate(s) configured to form and/or define a substantially flat, planar cooking surface for cooking one or more food item(s) placed thereon. For example, as shown in FIG. 40, the cookbox 4000 carries, supports, contains, houses, and/or otherwise includes an example first cooking grate 4014 and an example second cooking grate 4016, with the second cooking grate 4016 being positioned in a side-by-side arrangement relative to the first cooking grate 4014.

In the illustrated example of FIG. 40, the rotisserie spit 3300 and the rotisserie fork set 100 are respectively positioned on and/or within the cookbox 4000 above and/or over the first cooking grate 4014 and the second cooking grate 4016. The first cooking grate 4014 and the second cooking grate 4016 are respectively positioned within the cookbox 4000 above and/or over the grease deflection bar(s). The grease deflection bar(s) is/are positioned within the cookbox 4000 above and/or over the burner tube(s). In other examples, the first cooking grate 4014 and/or the second cooking grate 4016 can be removed from the cookbox 4000 to provide additional clearance for the rotisserie spit 3300 and/or the rotisserie fork set 100 within the cookbox 4000.

In the illustrated example of FIG. 40, the rotisserie fork set 100 is located forward of the rotisserie spit 3300, with the rear opening 936 of the mounting channel 928 of the first mounting bracket 106 of the first fork 102 and the rear opening 2136 of the mounting channel 2128 of the second mounting bracket 112 of the second fork 104 being respectively oriented toward the rotisserie spit 3300. As shown in FIG. 40, the mounting channel 928 of the first mounting bracket 106 of the first fork 102 and the mounting channel 2128 of the second mounting bracket 112 of the second fork 104 are laterally (e.g., axially) aligned with one another to advantageously enable concurrent transverse loading of the first fork 102 and the second fork 104 of the rotisserie fork set 100 onto the rotisserie spit 3300. In other examples, the respective transverse loading of the first fork 102 and the second fork 104 of the rotisserie fork set 100 onto the rotisserie spit 3300 can instead be performed in a non-concurrent manner. For example, the first mounting bracket 106 of the first fork 102 of the rotisserie fork set 100 can be transversely loaded onto the rotisserie spit 3300 at a first time, and the second mounting bracket 112 of the second fork 104 of the rotisserie fork set 100 can be transversely loaded onto the rotisserie spit 3300 at a second time subsequent to the first time.

In the illustrated example of FIG. 40, the first fastener 108 of the first fork 102 is positioned in an unlocked position (e.g., the unlocked position 1900 of FIGS. 19 and 20) and the first clip 110 of the first fork 102 is positioned in an open position (e.g., the open position 1902 of FIGS. 19 and 20) such that the first fastener 108 and the first clip 110 are not blocking any portion of the mounting channel 928 of the first mounting bracket 106 of the first fork 102 in preparation of the first mounting bracket 106 and/or, more generally, the first fork 102 being transversely loaded onto the rotisserie spit 3300. With the first fastener 108 and the first clip 110 of the first fork 102 being positioned in the unlocked position and/or the non-blocking manner described above, the first mounting bracket 106 and/or, more generally, the first fork 102 can be transversely loaded onto the rotisserie spit 3300 by moving the first mounting bracket 106 and/or, more generally, the first fork 102 in and/or along an example transverse direction 4018 (e.g., away from the front wall 4002 of the cookbox 4000 and toward the rear wall 4004 of the cookbox 4000) that is generally orthogonal relative to the longitudinal axis 3306 of the rotisserie spit 3300. The transverse loading of the first mounting bracket 106 and/or, more generally, the first fork 102 onto the rotisserie spit 3300 can advantageously be carried out and/or completed while the rotisserie spit 3300 remains positioned on the cookbox 4000 (e.g., while the first axial segment 3308 of the rotisserie spit 3300 remains positioned within the first notched portion 4010 of the right sidewall 4006 of the cookbox 4000, and while the second axial segment 3310 of the rotisserie spit 3300 remains positioned within the second notched portion 4012 of the left sidewall 4008 of the cookbox 4000).

Similarly, the second fastener 114 of the second fork 104 is positioned in an unlocked position (e.g., the unlocked position 3100 of FIGS. 31 and 32) and the second clip 116 of the second fork 104 is positioned in an open position (e.g., the open position 3102 of FIGS. 31 and 32) such that the second fastener 114 and the second clip 116 are not blocking any portion of the mounting channel 2128 of the second mounting bracket 112 of the second fork 104 in preparation of the second mounting bracket 112 and/or, more generally, the second fork 104 being transversely loaded onto the rotisserie spit 3300. With the second fastener 114 and the second clip 116 of the second fork 104 being positioned in the unblocked position and/or the non-blocking manner described above, the second mounting bracket 112 and/or, more generally, the second fork 104 can be transversely loaded onto the rotisserie spit 3300 by moving the second mounting bracket 112 and/or, more generally, the second fork 104 in and/or along the transverse direction 4018 (e.g., away from the front wall 4002 of the cookbox 4000 and toward the rear wall 4004 of the cookbox 4000) that is generally orthogonal relative to the longitudinal axis 3306 of the rotisserie spit 3300. The transverse loading of the second mounting bracket 112 and/or, more generally, the second fork 104 onto the rotisserie spit 3500 can advantageously be carried out and/or completed while the rotisserie spit 3300 remains positioned on the cookbox 4000 (e.g., while the first axial segment 3308 of the rotisserie spit 3300 remains positioned within the first notched portion 4010 of the right sidewall 4006 of the cookbox 4000, and while the second axial segment 3310 of the rotisserie spit 3300 remains positioned within the second notched portion 4012 of the left sidewall 4008 of the cookbox 4000).

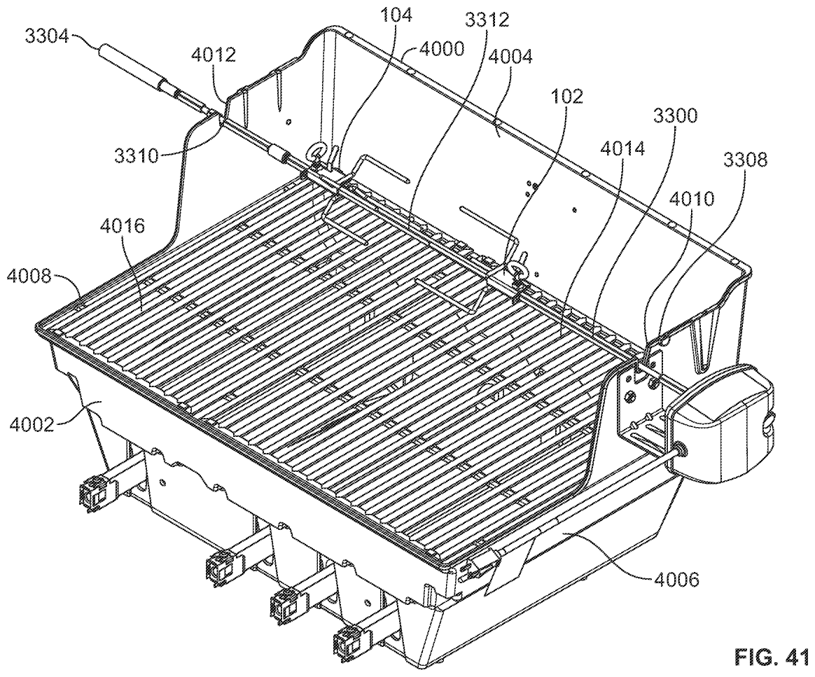

FIG. 41 is a perspective view of the cookbox 4000 of the grill of FIG. 40, showing the rotisserie fork set 100 of FIGS. 1-8 and 34-40 transversely loaded onto the rotisserie spit 3300 of FIGS. 33-40. In the illustrated example of FIG. 41, the first mounting bracket 106 and/or, more generally, the first fork 102 has been transversely loaded onto the rotisserie spit 3300 by moving the first mounting bracket 106 and/or, more generally, the first fork 102 away from the position shown in FIG. 40 and onto the rotisserie spit 3300 in and/or along the transverse direction 4018 shown in FIG. 40. Transversely loading the first mounting bracket 106 and/or, more generally, the first fork 102 onto the rotisserie spit 3300 as shown in FIG. 41 results in the rotisserie spit 3300 (e.g., the third axial segment 3312 of the rotisserie spit 3300) being located within and extending laterally (e.g., axially) through the mounting channel 928 of the first mounting bracket 106 of the first fork 102. As further shown in FIG. 41, the second mounting bracket 112 and/or, more generally, the second fork 104 has been transversely loaded onto the rotisserie spit 3300 by moving the second mounting bracket 112 and/or, more generally, the second fork 104 away from the position shown in FIG. 40 and onto the rotisserie spit 3300 in and/or along the transverse direction 4018 shown in FIG. 40. Transversely loading the second mounting bracket 112 and/or, more generally, the second fork 104 onto the rotisserie spit 3300 as shown in FIG. 41 results in the rotisserie spit 3300 (e.g., the third axial segment 3312 of the rotisserie spit 3300) being located within and extending laterally (e.g., axially) through the mounting channel 2128 of the second mounting bracket 112 of the second fork 104.

In the illustrated example of FIG. 41, the first fastener 108 has been moved from the unlocked position 1900 (e.g., as shown in FIGS. 19, 20, 34-36, and 40) into the locked position 1700 (e.g., as shown in FIGS. 17, 18, and 37-39), the first clip 110 has been moved from the open position 1902 (e.g., as shown in FIGS. 19, 20, 34-36, and 40) into the closed position 1702 (e.g., as shown in FIGS. 17, 18, and 37-39), the second fastener 114 has been moved from unlocked position 3100 (e.g., as shown in FIGS. 31, 32, 34-36, and 40) into the locked position 2900 (e.g., as shown in FIGS. 29, 30, and 37-39), and the second clip 116 has been moved from open position 3102 (e.g., as shown in FIGS. 31, 32, 34-36, and 40) into the closed position 2902 (e.g., as shown in FIGS. 29, 30, and 37-39). Positioning the first fastener 108 in the locked position 1700 securely couples the first mounting bracket 106 and/or, more generally, the first fork 102 to the rotisserie spit 3300 (e.g., to the third axial segment 3312 of the rotisserie spit 3300) such that the first mounting bracket 106 and/or, more generally, the first fork 102 rotate(s) along with the rotation (e.g., the motor-driven rotation) of the rotisserie spit 3300. Positioning the first clip 110 in the closed position 1702 provides a mechanical failsafe that prevents the first mounting bracket 106 and/or, more generally, the first fork 102 from inadvertently being transversely removed from the rotisserie spit 3300. Positioning the second fastener 114 in the locked position 2900 securely couples the second mounting bracket 112 and/or, more generally, the second fork 104 to the rotisserie spit 3300 (e.g., to the third axial segment 3312 of the rotisserie spit 3300) such that the second mounting bracket 112 and/or, more generally, the second fork 104 rotate(s) along with the rotation (e.g., the motor-driven rotation) of the rotisserie spit 3300. Positioning the second clip 116 in the closed position 2902 provides a mechanical failsafe that prevents the second mounting bracket 112 and/or, more generally, the second fork 104 from inadvertently being transversely removed from the rotisserie spit 3300.

Example transversely-loadable rotisserie forks are disclosed. In some disclosed examples, a rotisserie fork comprises a first upper prong and a second upper prong spaced apart from the first upper prong. In some disclosed examples, the rotisserie fork further comprises a first lower prong and a second lower prong spaced apart from the first lower prong. In some disclosed examples, the rotisserie fork further comprises a mounting bracket coupled to the first upper prong, the second upper prong, the first lower prong, and the second lower prong. In some disclosed examples, the mounting bracket is configured to be transversely loadable onto a rotisserie spit.

In some disclosed examples, the rotisserie fork further comprises an upper base located between and coupled to the first upper prong and the second upper prong.

In some disclosed examples, the first upper prong and the second upper prong are integrally formed with the upper base to provide an upper prong unit.

In some disclosed examples, the upper prong unit is coupled to the mounting bracket via the upper base.

In some disclosed examples, the rotisserie fork further comprises a lower base located between and coupled to the first lower prong and the second lower prong.

In some disclosed examples, the first lower prong and the second lower prong are integrally formed with the lower base to provide a lower prong unit.

In some disclosed examples, the lower prong unit is coupled to the mounting bracket via the lower base.

In some disclosed examples, the mounting bracket includes a mounting channel having an upper wall, a lower wall, a front wall, and a rear opening. In some disclosed examples, the mounting channel is configured to transversely receive the rotisserie spit via the rear opening.

In some disclosed examples, the mounting channel is configured to transversely receive an axial segment of the rotisserie spit, the axial segment having a rectangular cross-sectional profile.

In some disclosed examples, the rotisserie fork further comprises a fastener configured to be threadedly coupled to the mounting bracket.

In some disclosed examples, the fastener is tethered to the mounting bracket via a cable extending between the fastener and the mounting bracket.

In some disclosed examples, the fastener is movable relative to the mounting bracket between a locked position that partially obstructs a forward portion of the mounting channel and an unlocked position that does not obstruct the forward portion of the mounting channel.

In some disclosed examples, the rotisserie fork further comprises a clip pivotably coupled to the mounting bracket. In some disclosed examples, the clip includes an engagement portion configured to be selectively positioned within a slot of the mounting bracket.

In some disclosed examples, the clip is movable relative to the mounting bracket between a closed position that obstructs a rearward portion of the mounting channel and an open position that does not obstruct the rearward portion of the mounting channel.

In some disclosed examples, the engagement portion of the clip is further configured to be selectively positioned within an expansion notch of the slot. In some disclosed examples, the expansion notch provides a mechanical stop to restrict the engagement portion of the clip from inadvertently moving out of the slot.

In some examples, a rotisserie fork is disclosed. In some disclosed examples, the rotisserie fork comprises an upper prong and a lower prong. In some disclosed examples, the rotisserie fork further comprises a mounting bracket coupled to the upper prong and the lower prong. In some disclosed examples, the mounting bracket is configured to be transversely loadable onto a rotisserie spit.

In some disclosed examples, the mounting bracket includes a mounting channel having an upper wall, a lower wall, a front wall, and a rear opening. In some disclosed examples, the mounting channel is configured to transversely receive the rotisserie spit via the rear opening.

In some disclosed examples, the mounting channel is configured to transversely receive an axial segment of the rotisserie spit. In some disclosed examples, the axial segment has a rectangular cross-sectional profile.

In some disclosed examples, the rotisserie fork further comprises a fastener configured to be threadedly coupled to the mounting bracket. In some disclosed examples, the fastener is movable relative to the mounting bracket between a locked position that partially obstructs a forward portion of the mounting channel and an unlocked position that does not obstruct the forward portion of the mounting channel.

In some disclosed examples, the rotisserie fork further comprises a clip pivotably coupled to the mounting bracket. In some disclosed examples, the clip includes an engagement portion configured to be selectively positioned within a slot of the mounting bracket. In some disclosed examples, the clip is movable relative to the mounting bracket between a closed position that obstructs a rearward portion of the mounting channel and an open position that does not obstruct the rearward portion of the mounting channel.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A rotisserie fork, comprising:
a first upper prong;
a second upper prong spaced apart from the first upper prong;
a first lower prong;
a second lower prong spaced apart from the first lower prong; and
a mounting bracket coupled to the first upper prong, the second upper prong, the first lower prong, and the second lower prong, the mounting bracket configured to be transversely loadable onto a rotisserie spit.

2. The rotisserie fork of claim 1, further comprising an upper base located between and coupled to the first upper prong and the second upper prong.

3. The rotisserie fork of claim 2, wherein the first upper prong and the second upper prong are integrally formed with the upper base to provide an upper prong unit.

4. The rotisserie fork of claim 3, wherein the upper prong unit is coupled to the mounting bracket via the upper base.

5. The rotisserie fork of claim 1, further comprising a lower base located between and coupled to the first lower prong and the second lower prong.

6. The rotisserie fork of claim 5, wherein the first lower prong and the second lower prong are integrally formed with the lower base to provide a lower prong unit.

7. The rotisserie fork of claim 6, wherein the lower prong unit is coupled to the mounting bracket via the lower base.

8. The rotisserie fork of claim 1, wherein the mounting bracket includes a mounting channel having an upper wall, a lower wall, a front wall, and a rear opening, the mounting channel configured to transversely receive the rotisserie spit via the rear opening.

9. The rotisserie fork of claim 8, wherein the mounting channel is configured to transversely receive an axial segment of the rotisserie spit, the axial segment having a rectangular cross-sectional profile.

10. The rotisserie fork of claim 8, further comprising a fastener configured to be threadedly coupled to the mounting bracket.

11. The rotisserie fork of claim 10, wherein the fastener is tethered to the mounting bracket via a cable extending between the fastener and the mounting bracket.

12. The rotisserie fork of claim 10, wherein the fastener is movable relative to the mounting bracket between a locked position that partially obstructs a forward portion of the mounting channel and an unlocked position that does not obstruct the forward portion of the mounting channel.

13. The rotisserie fork of claim 8, further comprising a clip pivotably coupled to the mounting bracket, the clip including an engagement portion configured to be selectively positioned within a slot of the mounting bracket.

14. The rotisserie fork of claim 13, wherein the clip is movable relative to the mounting bracket between a closed position that obstructs a rearward portion of the mounting channel and an open position that does not obstruct the rearward portion of the mounting channel.

15. The rotisserie fork of claim 13, wherein the engagement portion is further configured to be selectively positioned within an expansion notch of the slot, the expansion notch providing a mechanical stop to restrict the engagement portion of the clip from inadvertently moving out of the slot.

16. A rotisserie fork, comprising:
an upper prong;
a lower prong; and
a mounting bracket coupled to the upper prong and the lower prong, the mounting bracket configured to be transversely loadable onto a rotisserie spit.

17. The rotisserie fork of claim 16, wherein the mounting bracket includes a mounting channel having an upper wall, a lower wall, a front wall, and a rear opening, the mounting channel configured to transversely receive the rotisserie spit via the rear opening.

18. The rotisserie fork of claim 17, wherein the mounting channel is configured to transversely receive an axial segment of the rotisserie spit, the axial segment having a rectangular cross-sectional profile.

19. The rotisserie fork of claim 17, further comprising a fastener configured to be threadedly coupled to the mounting bracket, the fastener being movable relative to the mounting bracket between a locked position that partially obstructs a forward portion of the mounting channel and an unlocked position that does not obstruct the forward portion of the mounting channel.

20. The rotisserie fork of claim 17, further comprising a clip pivotably coupled to the mounting bracket, the clip including an engagement portion configured to be selectively positioned within a slot of the mounting bracket, the clip being movable relative to the mounting bracket between a closed position that obstructs a rearward portion of the mounting channel and an open position that does not obstruct the rearward portion of the mounting channel.
